(19) United States
(12) Patent Application Publication
(10) Pub. No.: US 2014/0003598 A1
(43) Pub. Date: Jan. 2, 2014

(54) OPERATOR EVALUATION SUPPORT DEVICE AND OPERATOR EVALUATION SUPPORT METHOD

(71) Applicant: FUJITSU LIMITED, Kawasaki (JP)

(72) Inventors: Naoto KAWASHIMA, Yokohama (JP); Naoto Matsudaira, Yokohama (JP); Yuusuke Tounai, Nishi (JP); Hiroshi Yoshida, Yokohama (JP); Shingo Hirono, Yokohama (JP)

(73) Assignee: FUJITSU LIMITED, Kawasaki (JP)

(21) Appl. No.: 14/017,733

(22) Filed: Sep. 4, 2013

Related U.S. Application Data
(63) Continuation of application No. PCT/JP2011/055279, filed on Mar. 7, 2011.

(51) Int. Cl. H04M 3/51

(52) U.S. Cl. CPC H04M 3/5175
USPC 379/265.07

(57) ABSTRACT

An operator evaluation support device includes a speech recording unit for recording speech times of a customer and an operator during a telephone call; a display recording unit for recording a display time during which a display screen is displayed during the telephone call on an operator terminal, in association with display screen identification information; a content recording unit for recording screen content information describing a content of the display screen, in association with the display screen identification information; and a providing unit for referring to the above units with respect to the telephone call, creating telephone call information indicating the speech time, the display time of the display screen, and the screen content information, and sending the telephone call information to an administrator terminal used by an administrator who is evaluating the operator.

### CROSS-REFERENCE TO RELATED APPLICATION

This application is a U.S. continuation application filed under 35 USC 111(a) claiming benefit under 35 USC 120 and 365(c) of PCT Application JP2011/055279 filed on Mar. 7, 2011, the entire contents of which are incorporated herein by reference.

### FIELD

The embodiments discussed herein are related to an operator evaluation support device and an operator evaluation support method for supporting evaluation of an operator at a call center.

### BACKGROUND

In recent years, importance has been placed on improving the quality of an operator's telephone calls at call centers. The evaluation of the call quality of an operator is made by, for example, a supervisor controlling the operators. As one viewpoint of evaluating the call quality, for example, there is the length of the call time.

In the conventional technology, examples of an index for determining whether an appropriate service has been provided to the customer (i.e., customer satisfaction) are the length of time the customer has waited for his call to be taken, the number of times the customer's call has been transferred, and the time length of silence of the customer (see Patent Document 1).

By using the length of time the customer has waited for his call to be taken, the number of times the customer's call has been transferred, and the time length of silence of the customer, the supervisor estimates the customer's psychological state, and determines the customer satisfaction.

However, in addition to determining the customer satisfaction of a customer with respect to each operator, the supervisor is also to grasp whether the operator's response to the customer is appropriate. There is known the following conventional technology of evaluating the operator's response to the customer.

For example, the average time per call is calculated based on the time length of all of the calls with customers; the time of a call between an operator and a customer, which is an evaluation target, is compared with the average time; and the service skills of the operator are estimated (see Patent Document 2).

Alternatively, time information of a service sequence when servicing the customer is received for each operation task, the service time according to the operation task is estimated based on the time information for each of a plurality of service sequences, and the operation skill of the operator is estimated based on the estimated service time (see Patent Document 3).

However, even if the supervisor recognizes that there is a problem in the call between an operator and a customer due to the difference between the service time and the average service time of all operators, the supervisor is unable to easily find the portion of a problem in a call from a customer attended to by an operator.

That is to say, the supervisor is to appropriately supervise how the operator is to make services, based on the evaluation on the operator as described above. Therefore, the supervisor is to confirm the factor causing the call to exceed the average service time. However, unless the call record is played, the supervisor does not know the specific contents of the call. Furthermore, even when the call is played, the supervisor is to sequentially listen to the call from the beginning, because the supervisor is unaware of where the problem is in the call. This confirmation method is time-consuming and inefficient. Thus, there have been cases where the supervisor is unable to sufficiently confirm the contents of the call, and consequently incapable of giving appropriate supervision.
Patent Document 1: Japanese Laid-Open Patent Publication No. 2002-51153
Patent Document 2: Japanese Laid-Open Patent Publication No. 2005-258551
Patent Document 3: Japanese Laid-Open Patent Publication No. 2001-331624

### SUMMARY

According to an aspect of the embodiments, an operator evaluation support device includes a speech recording unit configured to record speech times of a customer and an operator during a telephone call from the customer to which the operator attends; a display recording unit configured to record a display time during which a display screen is displayed during the telephone call on an operator terminal used by the operator, in association with display screen identification information for identifying the display screen; a content recording unit configured to record screen content information describing a content of the display screen, in association with the display screen identification information of the display screen displayed on the operator terminal; and a providing unit configured to refer to the speech recording unit, the display recording unit, and the content recording unit with respect to the telephone call, create telephone call information indicating the speech times of the customer and the operator, the display time of the display screen displayed on the operator terminal, and the screen content information corresponding to the display screen, and send the telephone call information to an administrator terminal used by an administrator who is evaluating the operator.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 illustrates a configuration of a call center system according to an embodiment;

FIG. 2 is a hardware configuration diagram of a server;

FIG. 3 is a hardware configuration diagram of an operator terminal and an administrator terminal;

FIG. 4 is a function configuration diagram of the server;

FIG. 5 is a configuration diagram of a customer DB;

FIG. 6 is a configuration diagram of a question DB;

FIG. 7 is a configuration diagram of a FAQ DB;

FIG. 8 is a configuration diagram of a product DB;

FIG. 9 is a configuration diagram of an operator DB;

FIG. 10 is a configuration diagram of a voice DB;

FIG. 11 is a configuration diagram of a speech time DB;

FIG. 12 is a configuration diagram of a manual DB;

FIG. 13 is a configuration diagram of a page switch DB;

FIG. 14 is a configuration diagram of an evaluation DB;

FIG. 15 is a flowchart of a process according to a call program;

FIG. 16 is a flowchart of a recording process;

FIG. 17 is a flowchart of an operator speech confirmation process;

FIG. 18 is a flowchart of a customer speech confirmation process;

FIG. 19 is a flowchart of a process according to an information search program;

FIG. 20 is a flowchart of a process according to an OP evaluation program;

FIG. 21 is an image diagram of a process range selection screen;

FIG. 22 illustrates a configuration of a speech table data (work)-section table;

FIG. 23 illustrates a configuration of a speech table data (work)-call summary information;

FIG. 24 illustrates a configuration of a speech table data (work)-speech time table;

FIG. 25 is a flowchart of a speech table creating process;

FIG. 26 is a flowchart of a filling process;

FIG. 27 is screen image diagram of a speech table;

FIG. 28 is a function configuration diagram of the operator terminal;

FIG. 29 is a function configuration diagram of the administrator terminal; and

FIG. 30 is a flowchart of a process performed by the administrator terminal.

### DESCRIPTION OF EMBODIMENTS

Preferred embodiments of the present invention will be explained with reference to accompanying drawings.

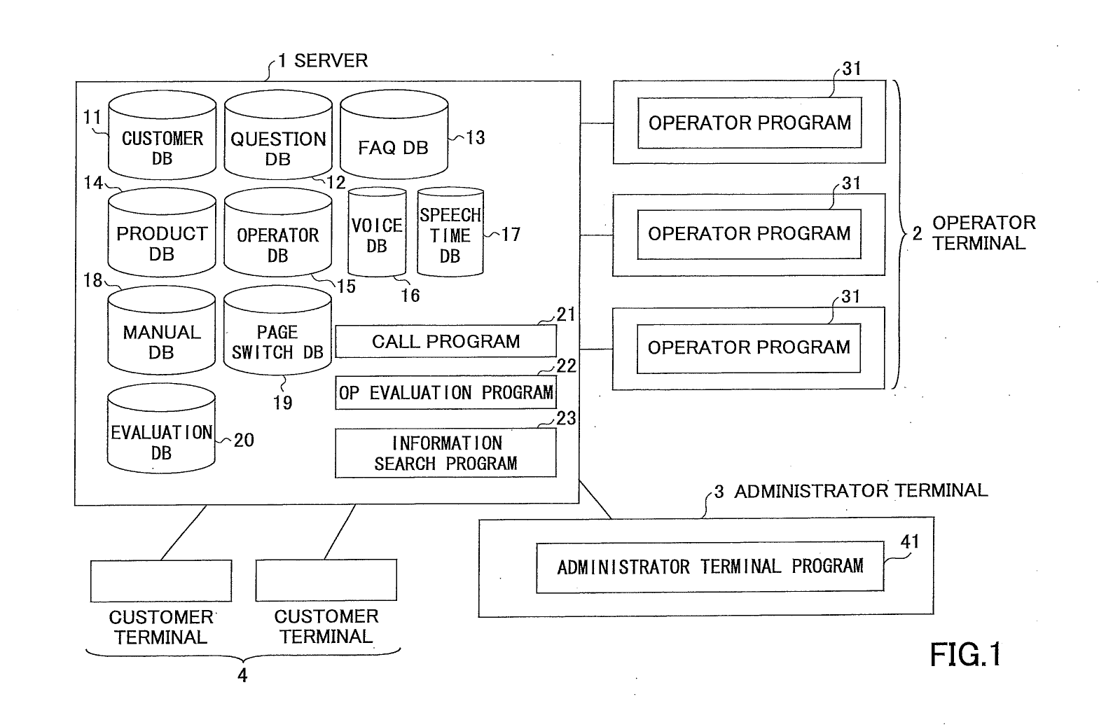

FIG. 1 illustrates a configuration of a call center system according to the present embodiment. The call center system of FIG. 1 includes a server 1, an operator terminal 2, an administrator terminal 3, and a customer terminal 4. The server 1 is an example of an operator evaluation support device.

The server 1 is connected to the operator terminal 2, the administrator terminal 3, and the customer terminal 4 via a predetermined network such as the Internet, a LAN (Local Area Network), and a public network.

The server 1 includes a customer DB 11, a question DB 12, a FAQ DB 13, a product DB 14, an operator DB 15, a voice DB 16, a speech time DB 17, a manual DB 18, a page switch DB 19, an evaluation DB 20, a call program 21, an OP (operator) evaluation program 22, and an information search program 23. Furthermore, the operator terminal 2 includes an operator program 31. The administrator terminal 3 includes an administrator terminal program 41. The administrator terminal 3 is operated by a supervisor, who is an example of the administrator.

The server 1 executes the call program 21, the OP evaluation program 22, and the information search program 23. By executing the call program 21, the server 1 connects with the customer terminal 4 and the operator terminal 2, records calls, and sends information of the customer to the operator terminal 2.

Furthermore, by executing the OP evaluation program 22, the server 1 creates information used by the supervisor for evaluating the operator, and sends information used by the supervisor for evaluating the operator to the administrator terminal 3.

Furthermore, by executing the information search program 23, the server 1 searches the manual DB 18 for information, sends the search results to the operator terminal 2, and records the contents of the information sent to the operator terminal 2 and the times at which the information is displayed and hidden at the operator terminal 2.

The operator terminal 2 executes the operator program 31. By executing the operator program 31, the operator terminal 2 displays information of the customer received from the server 1, and displays the search results of the information from the manual DB 18. The administrator terminal 3 executes the administrator terminal program 41. By executing the administrator terminal program 41, the administrator terminal 3 displays information used by the supervisor for evaluating the operator, which has been received from the server 1. Note that the customer terminal 4 may be any device having a telephone function, such as a telephone, and a PC having a telephone function.

The customer DB 11 records information relevant to the customer. The question DB 12 records information relevant to inquiries from the customer. The FAQ DB 13 records information relevant to FAQ (Frequently Asked Questions). The product DB 14 records information relevant to products.

The operator DB 15 records information relevant to the state of the operator (attending to a call, available, etc.). The voice DB 16 records information relevant to a voice file. The speech time DB 17 records information relevant to the speech of the customer and the operator, such as the timing of the speech of the customer and the operator.

The manual DB 18 records the screen data and the standard duration of each section (page) of the manual. The page switch DB 19 records information relevant to the operation of displaying or the hiding of the manual performed by the operator. The evaluation DB 20 records information relevant to the evaluation based on the difference between the standard duration and the actual duration.

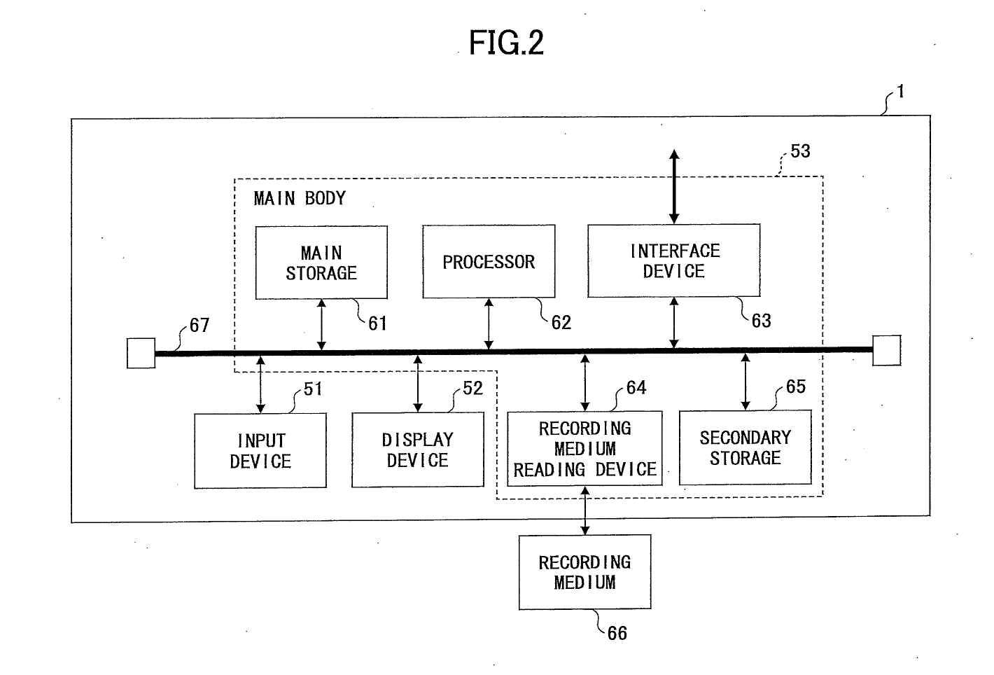

FIG. 2 is a hardware configuration diagram of the server. The server 1 illustrated in FIG. 2 includes an input device 51, a display device 52, and a main body 53. The main body 53 includes a main storage 61, a processor 62, an interface device 63, a recording medium reading device 64, and a secondary storage 65, which are interconnected by a bus 67. The input device 51 and the display device 52 are connected to the bus 67.

The input device 51, the display device 52, the main storage 61, the processor 62, the interface device 63, the recording medium reading device 64, and the secondary storage 65, which are interconnected by the bus 67, may exchange data with each other under the control of the processor 62. The processor 62 is a CPU (Central Processing Unit) that controls the operations of the entire server 1.

The interface device 63 receives data from the operator terminal 2, the administrator terminal 3, and the customer terminal 4, and passes the contents of the data to the processor 62. Furthermore, the interface device 63 sends data to the operator terminal 2, the administrator terminal 3, and the customer terminal 4 according to instructions from the processor 62.

The secondary storage 65 stores an operator evaluation support program that causes a computer to perform a process in at least the operator evaluation support device, as part of the program for causing the server 1 to exhibit the same functions as the operator evaluation support device. The operator evaluation support program includes the call program 21, the OP evaluation program 22, and the information search program 23.

Then, as the processor 62 reads the operator evaluation support program from the secondary storage 65 and executes the operator evaluation support program, the server 1 functions as an operator evaluation support device. The operator evaluation support program may be stored in the main storage 61 accessible by the processor 62. The input device 51 receives input of data under the control of the processor 62. The operator evaluation support program may be recorded in a recording medium 66 readable by the server 1.

The recording medium 66 readable by the server 1 may be a magnetic recording medium, an optical disk, a magneto-optical recording medium, and a semiconductor memory. Examples of the magnetic recording medium are a HDD, a flexible disk (FD), and a magnetic tape (MT). Examples of an optical disk are a DVD (Digital Versatile Disc), a DVD-RAM, a CD-ROM (Compact Disc-Read Only Memory), and a CD-R (Recordable)/RW (ReWritable). An example of a magneto-optical recording medium is a MO (Magneto-Optical disk).

When distributing the operator evaluation support program, for example, a portable recording medium 66 such as a DVD and a CD-ROM recording the operator evaluation support program may be sold.

For example, in the server 1 executing the operator evaluation support program, the recording medium reading device 64 reads the operator evaluation support program from the recording medium 66 recording the operator evaluation support program. The processor 62 stores the read operator evaluation support program in the main storage 61 or the secondary storage 65. The server 1 reads the operator evaluation support program from the main storage 61 or the secondary storage 65 that is a storage device included in itself, and executes a process in accordance with the operator evaluation support program.

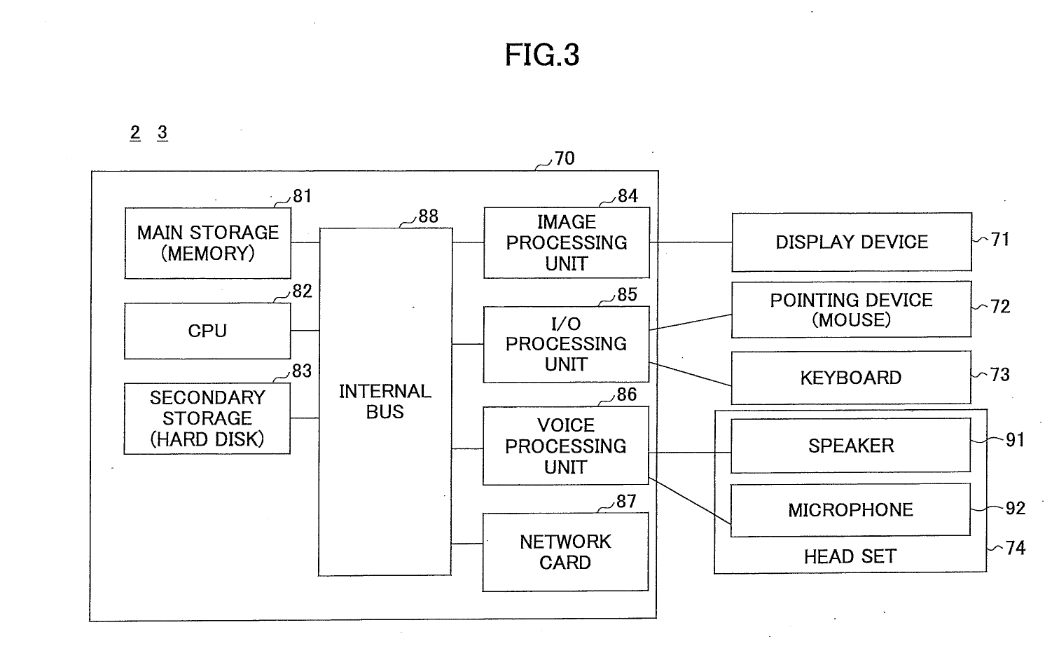

FIG. 3 is a hardware configuration diagram of the operator terminal 2 and the administrator terminal 3. The operator terminal 2 and the administrator terminal 3 have the same hardware configuration. Thus, in the following, a description is given of the hardware configuration of the operator terminal 2. A description of the hardware configuration of the administrator terminal 3 is omitted.

The operator terminal 2 of FIG. 3 includes a main body 70, a display device 71, a pointing deice 72, a keyboard 73, and a head set 74. The main body 70 includes a main storage 81, a CPU 82, a secondary storage 83, an image processing unit 84, an I/O processing unit 85, a voice processing unit 86, and a network card 87, which are interconnected by an internal bus 88. The head set 74 includes a speaker 91 and a microphone 92.

The main storage 81, the secondary storage 83, the image processing unit 84, the I/O processing unit 85, the voice processing unit 86, and the network card 87, which are interconnected by the internal bus 88, may exchange data under the control of the CPU 82. The CPU 82 is a Central Processing Unit that controls the operations of the entire operator terminal 2.

The image processing unit 84 is for performing various processes for displaying an image with the display device 71. The I/O processing unit 85 processes the input and output of data with the pointing deice 72 and the keyboard 73. The voice processing unit 86 processes voice data exchanged with the speaker 91 and the microphone 92 of the head set 74.

The network card 87 receives data from the server 1, and passes the contents of the data to the CPU 82. Furthermore, the network card 87 sends data to the server 1 according to instructions from the CPU 82.

For example, in the operator terminal 2, the operator program 31 is installed. The operator terminal 2 executes the operator program 31. In the main storage 81, as part of a program for operating the operator terminal 2, at least the operator program 31 is stored. The CPU 82 reads the operator program 31 from the main storage 81 and executes the operator program 31.

The operator program 31 may be recorded in a recording medium readable by the operator terminal 2. When distributing the operator program 31, for example, a portable recording medium such as a DVD and a CD-ROM recording the operator program 31 may be sold. An application distribution mechanism on the Internet may be used.

The operator terminal 2 that executes the operator program 31 reads the operator program 31 from a recording medium recording the operator program 31. The CPU 82 stores the operator program 31 in the main storage 81. The CPU 82 reads the operator program 31 from the main storage 81, and executes a process according to the operator program 31.

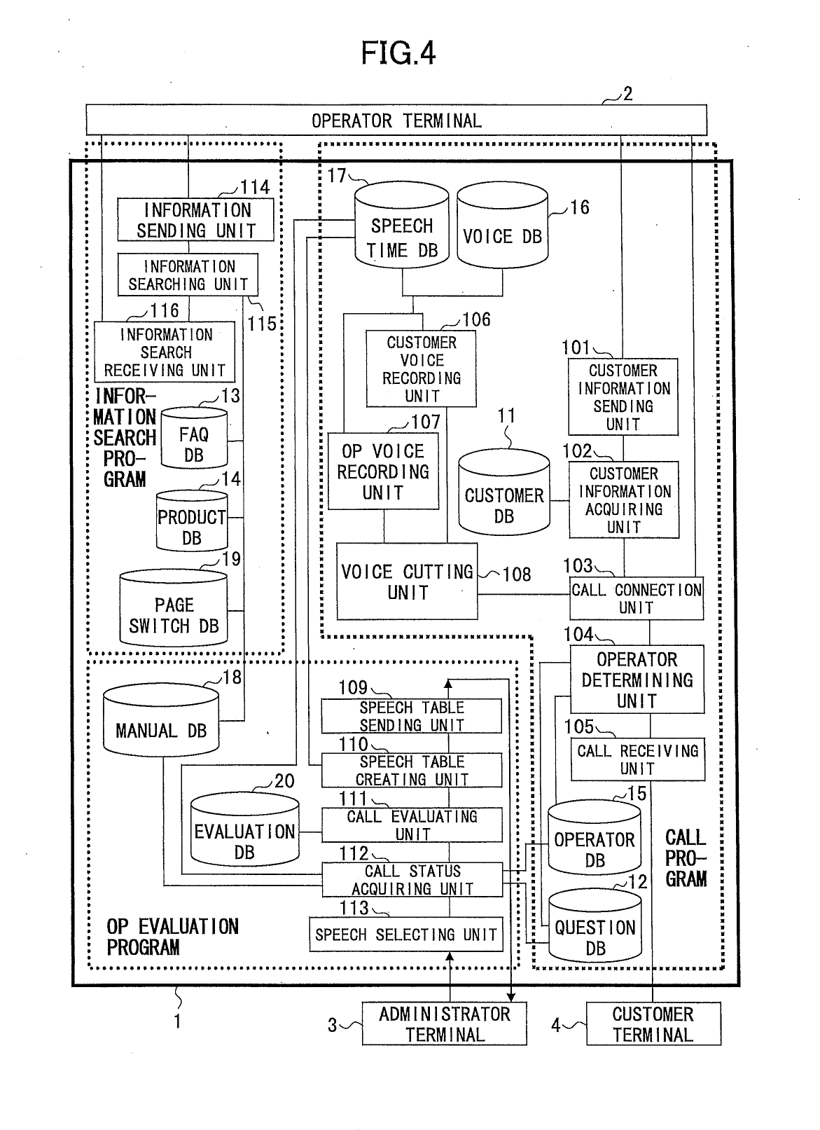

FIG. 4 is a function configuration diagram of the server 1. The server 1 includes a customer DB 11, a question DB 12, a FAQ DB 13, a product DB 14, an operator DB 15, a voice DB 16, a speech time DB 17, a manual DB 18, a page switch DB 19, and an evaluation DB 20.

By executing the call program 21, the server 1 realizes a customer information sending unit 101, a customer information acquiring unit 102, a call connection unit 103, an operator determining unit 104, a call receiving unit 105, a customer voice recording unit 106, an OP voice recording unit 107, and a voice cutting unit 108.

Furthermore, by executing the OP evaluation program 22, the server 1 realizes a speech table sending unit 109, a speech table creating unit 110, a call evaluating unit 111, a call status acquiring unit 112, and a speech selecting unit 113. Furthermore, by executing the information search program 23, the server realizes an information sending unit 114, an information searching unit 115, and an information search receiving unit 116.

The customer information sending unit 101 sends information of the customer to the operator terminal 2. The customer information acquiring unit 102 acquires information of the customer from the customer DB 11. The call connection unit 103 connects the operator terminal 2 with the customer terminal 4. The operator determining unit 104 determines an operator who is not attending to a call from the operator DB 15. The call receiving unit 105 receives a call from the customer terminal 4.

The customer voice recording unit 106 writes the voice data of the customer in a voice file. The customer voice recording unit 106 writes the speech start time and the speech end time of the customer in the speech time DB 17. The OP voice recording unit 107 writes the voice data of the operator in the voice file. The OP voice recording unit 107 writes the speech start time and the speech end time of the operator in the speech time DB 17.

The voice cutting unit 108 separates the voice data of the customer from the voice data of the operator. For example, the voice cutting unit 108 cuts the right channel of the voice data as voice data of the customer, and cuts the left channel of the voice data as voice data of the operator.

The speech table sending unit 109 sends a speech table to the administrator terminal 3. The speech table creating unit 110 creates a speech table. The call evaluating unit 111 evaluates each call by using the evaluation DB 20.

The call status acquiring unit 112 acquires information for evaluating each call as call status, from the question DB 12, the operator DB 15, the manual DB 18, and the page switch DB 19. The speech selecting unit 113 receives a speech table display request from the administrator terminal 3.

The information sending unit 114 sends the information searched from the FAQ DB 13, the product DB 14, and the manual DB 18, to the operator terminal 2. The information searching unit 115 searches for information in the FAQ DB 13, the product DB 14, and the manual DB 18. The information search receiving unit 116 receives a request to search for information from the operator terminal 2.

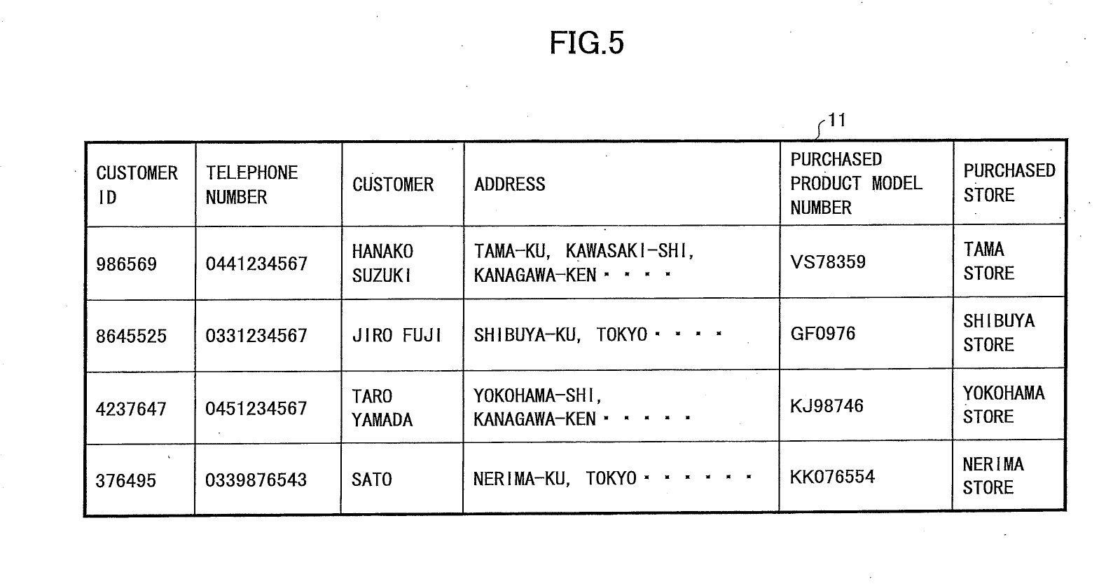

FIG. 5 is a configuration diagram of the customer DB 11. The customer DB 11 includes data items such as a customer ID, a telephone number, a customer, an address, a purchased product model number, and a purchased store.

The data item “customer ID” is identification information for uniquely identifying a customer. The data item “telephone number” is the customer's telephone number. The data item “customer” is the name of the customer. The data item “address” is the address of the customer. The data item “purchased product model number” is the model number of the product purchased by the customer. The data item “purchased store” is the store at which the customer purchased the product.

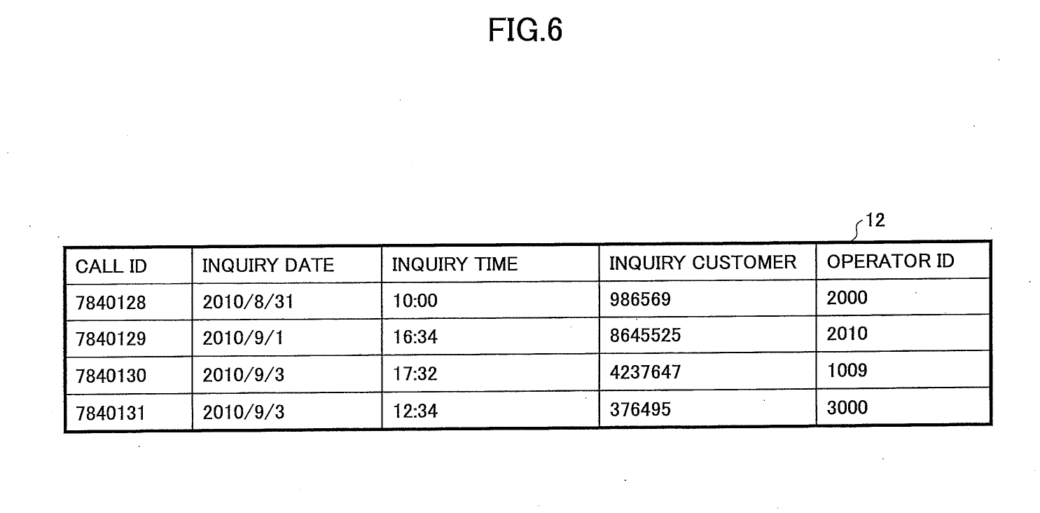

FIG. 6 is a configuration diagram of the question DB 12. The question DB 12 includes data items such as a call ID, an inquiry date, an inquiry time, an inquiry customer, and an operator ID.

The data item “call ID” is identification information for uniquely identifying a call. The data item “inquiry date” is the date on which the call from the customer is received. The data item “inquiry time” is the time at which a call from a customer is received. The data item “inquiry customer” is the customer ID of the customer that has made the inquiry. The data item “operator ID” is the operator ID of the operator who attended to the inquiry from the customer.

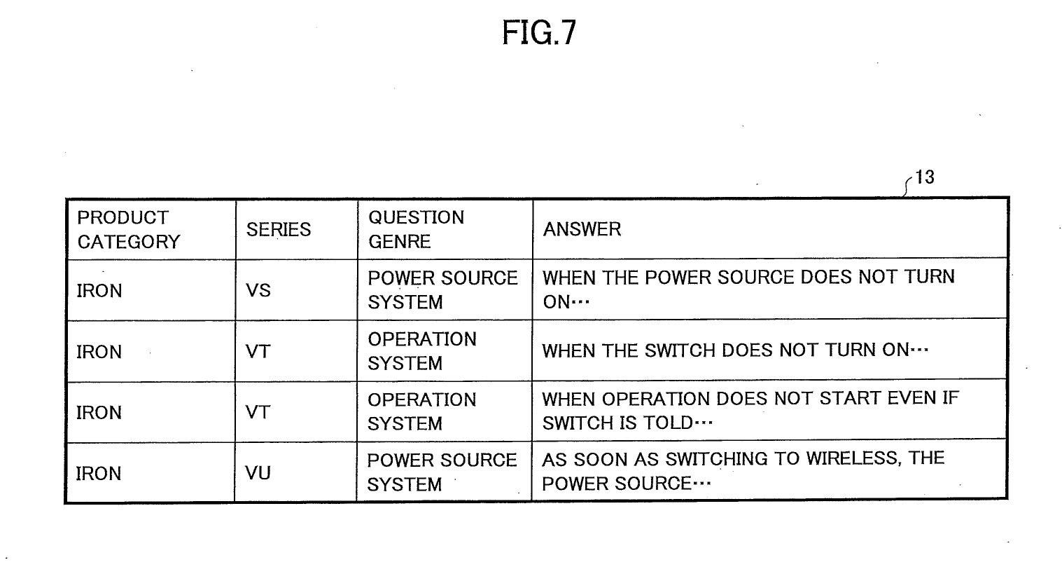

FIG. 7 is a configuration diagram of the FAQ DB 13. The FAQ DB 13 includes data items such as a product category, series, question genre, and answer. The FAQ DB 13 records a text of an answer for each of the product category, the series, and the question genre of a product.

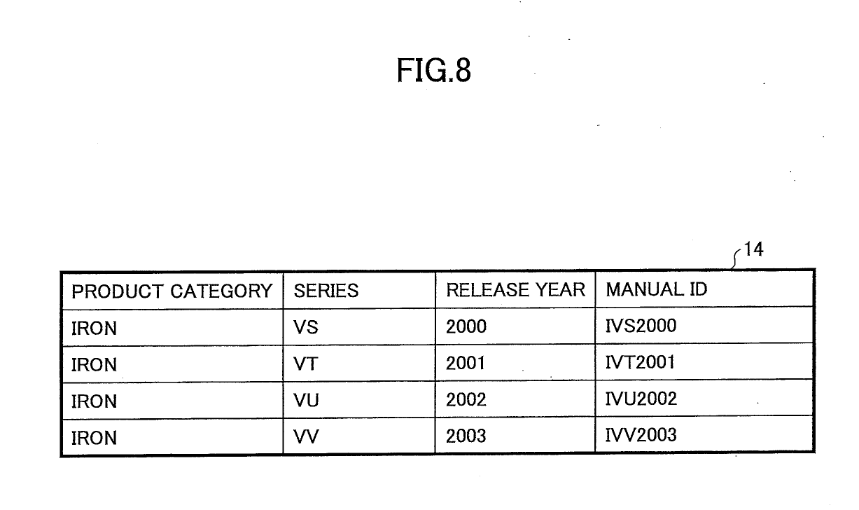

FIG. 8 is a configuration diagram of the product DB 14. The product DB 14 includes data items such as a product category, series, a release year, and a manual ID. The product DB 14 records a manual ID for the product category, series, and the release year of the product. The data item “manual ID” is identification information for uniquely identifying the manual.

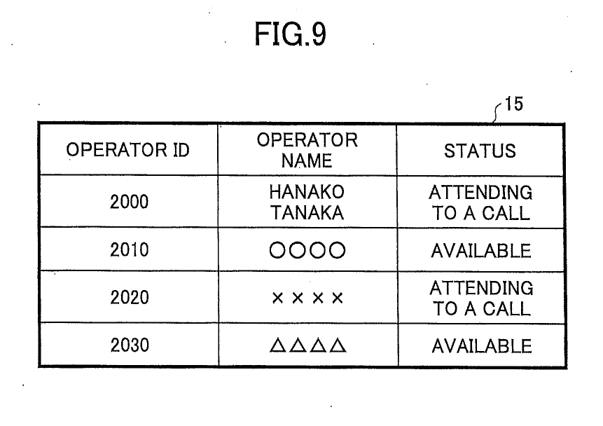

FIG. 9 is a configuration diagram of the operator DB 15. The operator DB 15 includes data items such as an operator ID, an operator name, and a status. The operator DB 15 records the status of “attending to a call” or “available” for each operator. The data item “status” is information indicating whether the operator is able to attend to an inquiry from the customer.

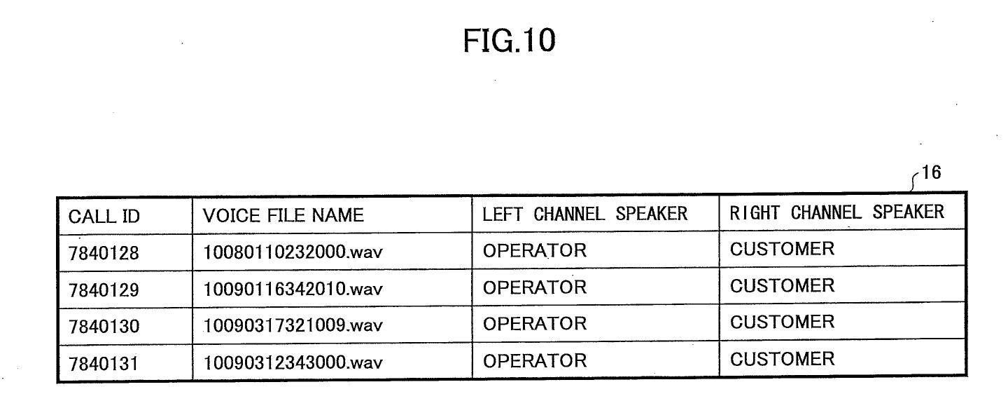

FIG. 10 is a configuration diagram of the voice DB 16. The voice DB 16 includes data items such as a call ID, a voice file name, a left channel speaker, and a right channel speaker. The voice DB 16 records, for each call ID, the voice file name, a left channel speaker, and a right channel speaker.

The data item “voice file name” is the file name of a voice file recording the call corresponding to the call ID. The data item “left channel speaker” is the speaker of the voice data written in the left channel. The data item “right channel speaker” is the speaker of the voice data written in the right channel.

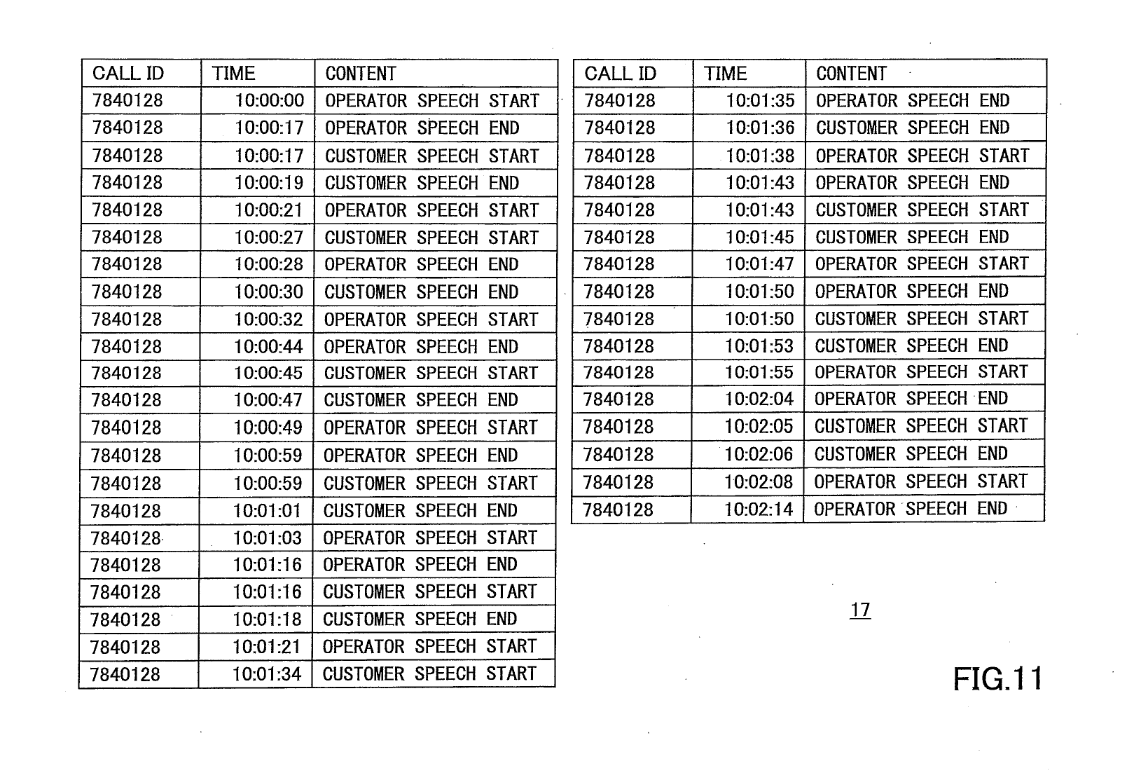

FIG. 11 is a configuration diagram of the speech time DB 17. The speech time DB 17 includes data items such as a call ID, a time, and contents.

The speech time DB 17 records the speech start time of the operator, the speech end time of the operator, the speech start time of the customer, and the speech end time of the customer, in association with a call ID.

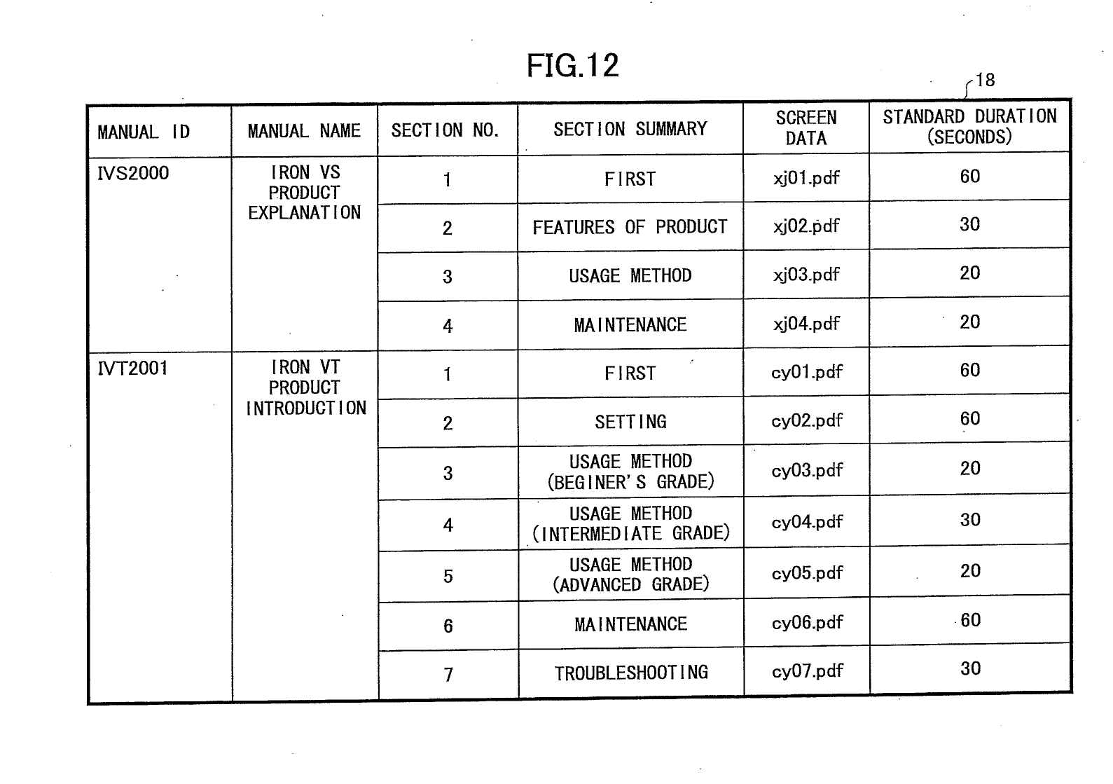

FIG. 12 is a configuration diagram of the manual DB 18. The manual DB 18 includes data items such as a manual ID, a manual name, a section number (hereinafter, “section no.”), a section summary, screen data, and a standard duration.

The manual DB 18 records a section summary, screen data, and a standard duration for each section no. of the manual. The data item “section no.” is the page of the manual. The data item “section summary” is the summary of the page of the manual expressed by the section no. The data item “screen data” is the screen data of the page of the manual expressed by the section no. The screen data is preferably in a data format in which text search is possible. When a single “section” extends across a plurality of pages, the screen data may include a plurality of pages. The data item “standard duration” is the standard duration during which the page of the manual expressed by the section no. is displayed. The standard duration may be the average time of the durations of all operators, or a time that is set by the administrator in advance.

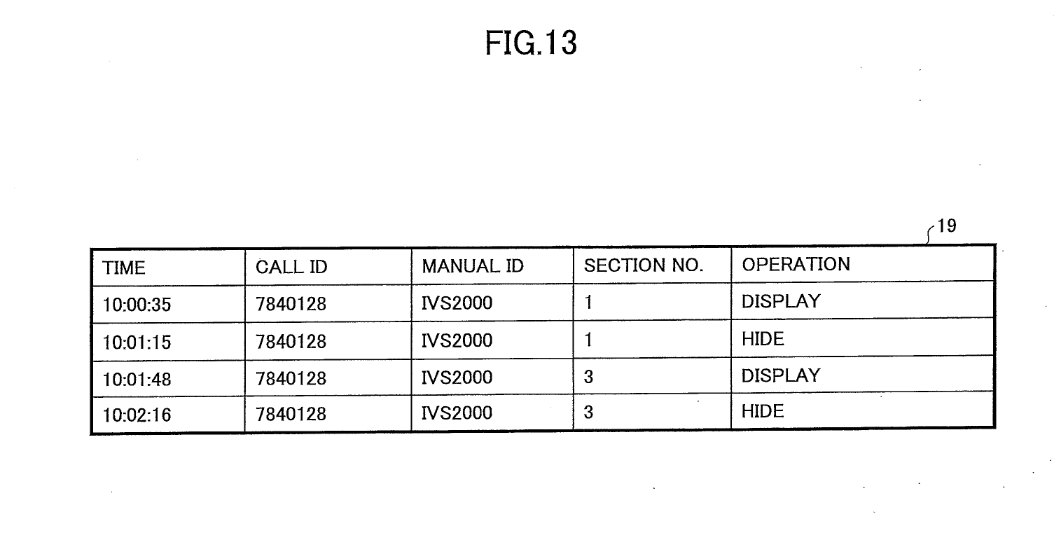

FIG. 13 is a configuration diagram of the page switch DB 19. The page switch DB 19 includes data items such as a time, a call ID, a manual ID, a section no., and an operation. The page switch DB 19 records the operation of displaying and hiding a page of the manual expressed by a manual ID and a section no., in association with the call ID and the time.

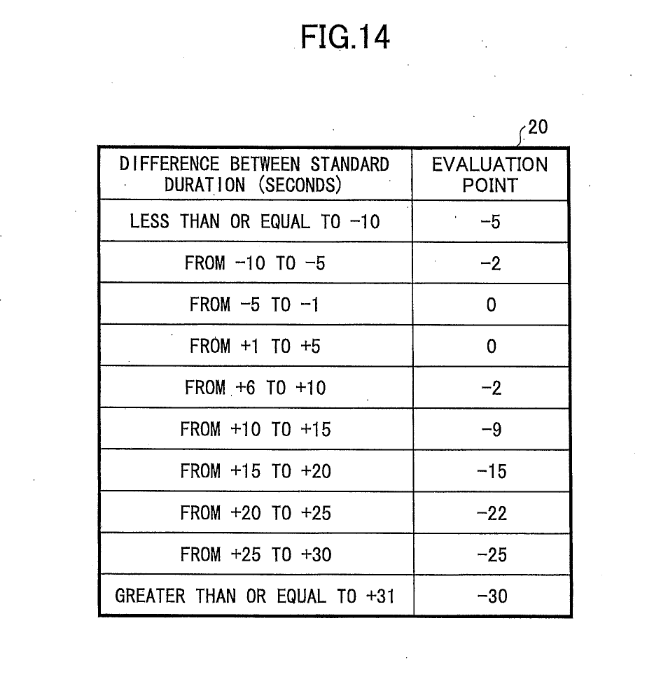

FIG. 14 is a configuration diagram of the evaluation DB 20. The evaluation DB 20 includes data items such as the difference with the standard duration and an evaluation point. The evaluation DB 20 records an evaluation point for each difference with the standard duration.

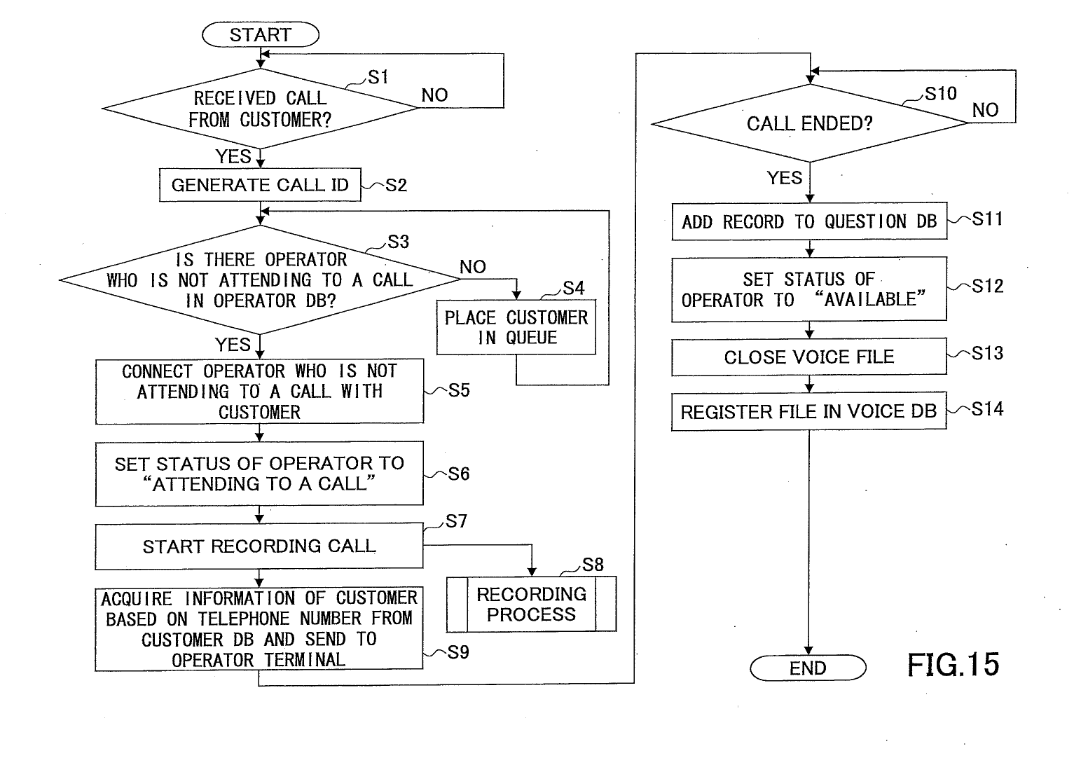

FIG. 15 is a flowchart of a process according to the call program 21. In step S1, the call receiving unit 105 of the server 1 waits until a call is received from the customer terminal 4. When a call is received from the customer terminal 4, the call receiving unit 105 generates a call ID in step S2.

In step S3, the operator determining unit 104 refers to the operator DB 15, and determines whether there is an operator whose “status” data item is not “attending to a call” (available). When there is no operator who is not “attending to a call”, in step S4, the operator determining unit 104 places the customer from which a call is received in a queue.

Then, the operator determining unit 104 waits until it is determined that there is an operator who is not “attending to a call”. When the operator determining unit 104 determines that there is a operator who is not “attending to a call”, the call connection unit 103 selects one operator who is not “attending to a call”, and connects the operator terminal 2 of the selected operator with the customer terminal 4 (step S5).

In step S6, the operator determining unit 104 sets the “status” data item of the selected operator in the operator DB 15 to “attending to a call”. Then, in step S7, the call connection unit 103 starts to record the call. The recording process of step S8 is executed after the recording of the call is started.

When the recording of the call is started, in step S9, the customer information acquiring unit 102 acquires information of the customer based on the telephone number of the call from the customer DB 11. The customer information sending unit 101 sends the information of the customer to the operator terminal 2.

In step S10, the operator determining unit 104 waits until the call ends. When the call ends, in step S11, the operator determining unit 104 adds a record relevant to the ended call to the question DB 12. In step S12, the operator determining unit 104 sets the data item “status” of the operator whose call has ended in the operator DB 15 as available. In step S13, the call connection unit 103 closes the voice file. In step S14, the call connection unit 103 registers, in the voice DB 16, a record relevant to the voice file of the ended call.

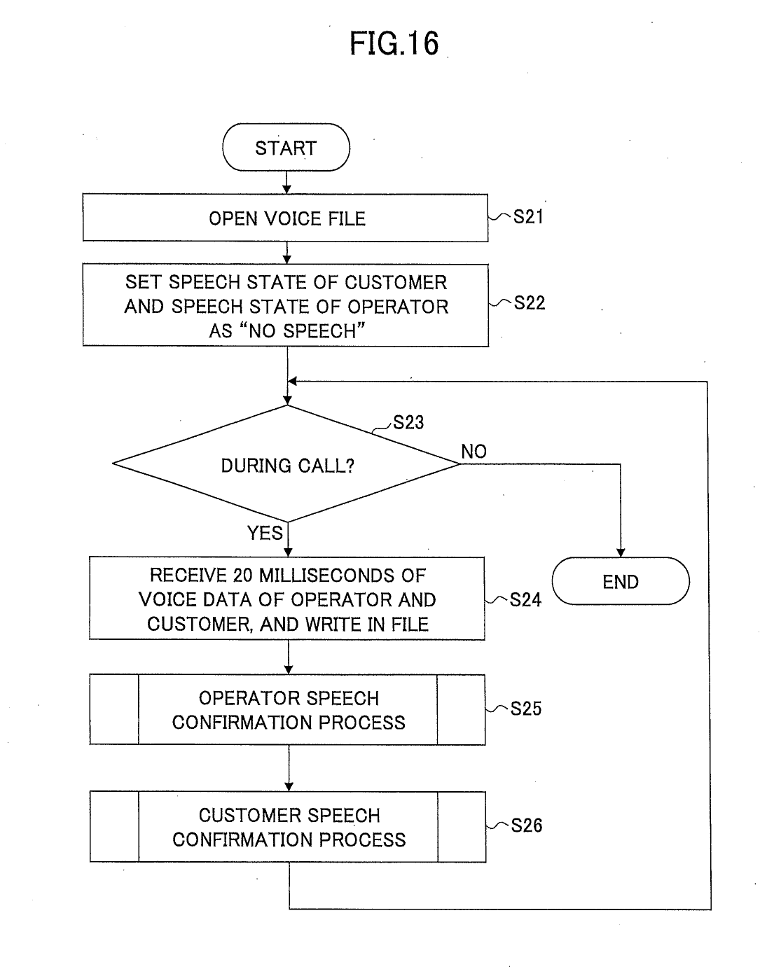

FIG. 16 is a flowchart of a recording process. In step S21, the call connection unit 103 opens a voice file. In step S22, the customer voice recording unit 106 sets the speech state of the customer as “no speech”. The OP voice recording unit 107 sets the speech state of the operator as “no speech”. In step S23, it is determined whether the call has ended, and the customer voice recording unit 106 and the OP voice recording unit 107 repeat steps S24 through S26 until the call ends.

In step S24, the customer voice recording unit 106 receives 20 milliseconds of the voice data of a customer among the voice data of the customer that has been cut by the voice cutting unit 108, and writes the received voice data in the voice file. The OP voice recording unit 107 receives 20 milliseconds of the voice data of an operator among the voice data of the operator that has been cut by the voice cutting unit 108, and writes the received voice data in the voice file.

In step S25, the customer voice recording unit 106 performs an operator speech confirmation process described below, confirms the speech start time and the speech end time of the operator, and writes the speech start time and the speech end time in the speech time DB 17. Furthermore, in step S26, the customer voice recording unit 106 performs a customer speech confirmation process described below, confirms the speech start time and the speech end time of the customer, and writes the speech start time and the speech end time in the speech time DB 17.

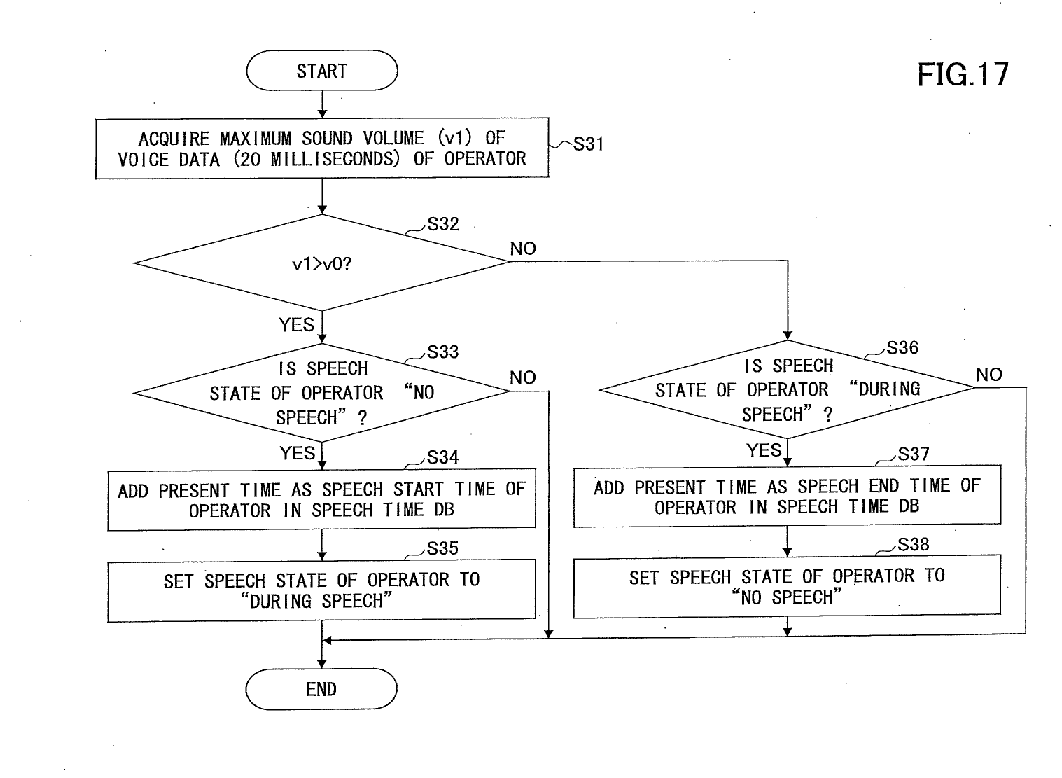

FIG. 17 is a flowchart of an operator speech confirmation process. In step S31, the OP voice recording unit 107 acquires the maximum sound volume (v1) of 20 milliseconds of the voice data of the operator.

In step S32, the OP voice recording unit 107 compares the maximum sound volume (v1) of the voice data of the operator with the sound volume (v0) determined as silent, and determines whether v1>v0 is satisfied.

When the OP voice recording unit 107 determines that v1>v0 is satisfied, the OP voice recording unit 107 determines whether the speech state of the operator is “no speech” in step S33. When the speech state of the operator is “no speech”, in step S34, the OP voice recording unit 107 records the present time as the speech start time of the operator, in the speech time DB 17.

In step S35, the OP voice recording unit 107 sets the speech state of the operator to “during speech”, and then ends the operator speech confirmation process of FIG. 17. When the speech state of the operator is not “no speech” in step S33, the OP voice recording unit 107 ends the operator speech confirmation process of FIG. 17.

When the OP voice recording unit 107 determines that v1>v0 is not satisfied, in step S36, the OP voice recording unit 107 determines whether the speech state of the operator is “during speech”. When the speech state of the operator is “during speech”, in step S37, the OP voice recording unit 107 records the present time as the speech end time of the operator in the speech time DB 17.

In step S38, the OP voice recording unit 107 sets the speech state of the operator to “no speech”, and then ends the operator speech confirmation process of FIG. 17. When the speech state of the operator is not “during speech” in step S36, the OP voice recording unit 107 ends the operator speech confirmation process of FIG. 17.

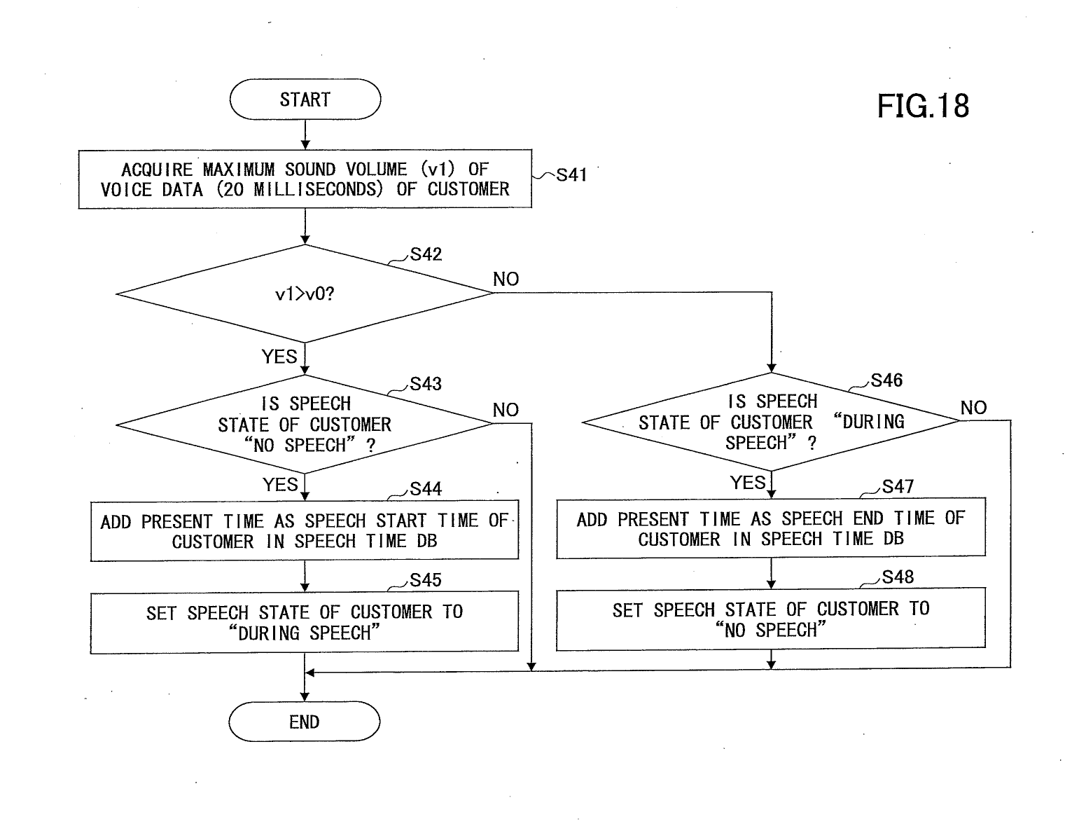

FIG. 18 is a flowchart of a customer speech confirmation process. In step S41, the customer voice recording unit 106 acquires the maximum sound volume (v1) of 20 milliseconds of the voice data of the customer.

In step S42, the customer voice recording unit 106 compares the maximum sound volume (v1) of the voice data of the customer with the sound volume (v0) determined as silent, and determines whether v1>v0 is satisfied.

When the customer voice recording unit 106 determines that v1>v0 is satisfied, in step S43, the customer voice recording unit 106 determines whether the speech state of the customer is “no speech”. When the speech state of the customer is “no speech”, in step S44, the customer voice recording unit 106 records the present time as the speech start time of the customer in the speech time DB 17.

In step S45, the customer voice recording unit 106 sets the speech state of the customer to “during speech”, and then ends the customer speech confirmation process of FIG. 18. When the speech state of the customer is not “no speech” in step S43, the customer voice recording unit 106 ends the customer speech confirmation process of FIG. 18.

When the customer voice recording unit 106 determines that v1>v0 is not satisfied, in step S46, the customer voice recording unit 106 determines whether the speech state of the customer is “during speech”. When the speech state of the customer is “during speech”, in step S47, the customer voice recording unit 106 records the present time as the speech end time of the customer in the speech time DB 17.

In step S48, the customer voice recording unit 106 sets the speech state of the customer to “no speech”, and then ends the customer speech confirmation process of FIG. 18. When the speech state of the customer is not “during speech” in step S46, the customer voice recording unit 106 ends the customer speech confirmation process of FIG. 18.

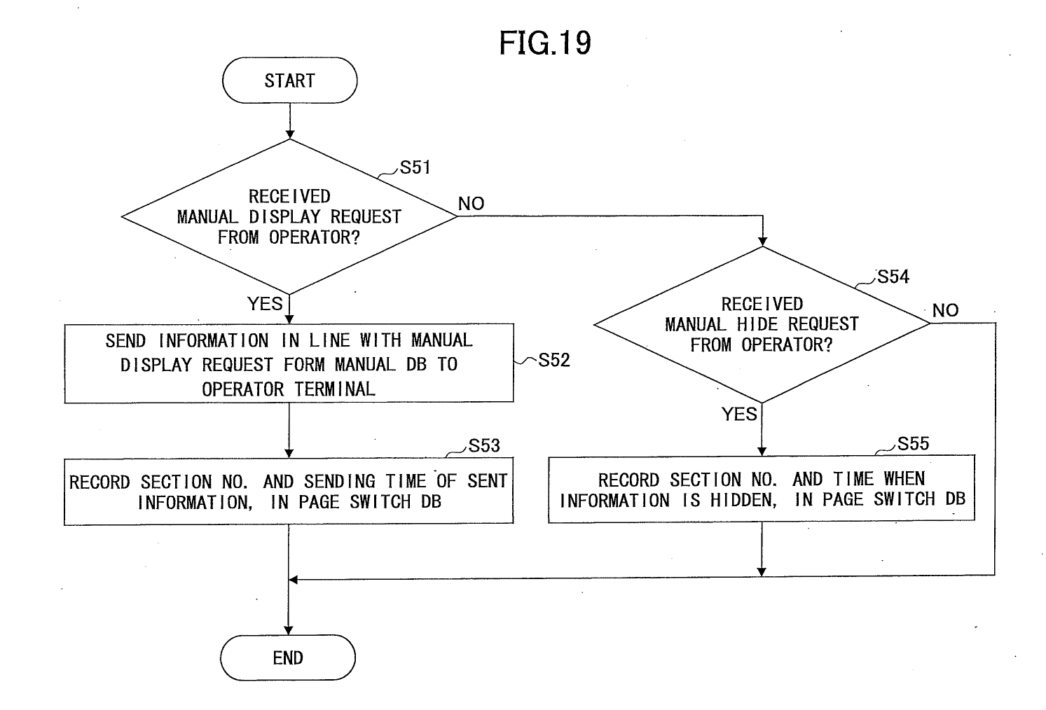

FIG. 19 is a flowchart of a process according to an information search program 23. In step S51, the information search receiving unit 116 determines whether a manual display request is received from the operator terminal 2.

When a manual display request is received, in step S52, the information searching unit 115 searches for information in line with the manual display request, in the manual DB 18. The information sending unit 114 sends the information in line with the manual display request to the operator terminal 2.

In step S53, the information searching unit 115 records, in the page switch DB 19, a record of information in line with the manual display request sent to the operator terminal 2 (for example, the time, a call ID, a manual ID, a section no., an operation), and then ends the process of the flowchart of FIG. 19.

Meanwhile, when the manual display request is not received, in step S54, the information searching unit 115 determines whether a manual hide request is received from the operator terminal 2. When a manual hide request is received, in step S55, the information searching unit 115 records, in the page switch DB 19, a record of information that has been hidden in line with the manual hide request (for example, the time, a call ID, a manual ID, a section no., an operation), and then ends the process of the flowchart of FIG. 19. When the manual hide request is not received, the information searching unit 115 ends the process of the flowchart of FIG. 19.

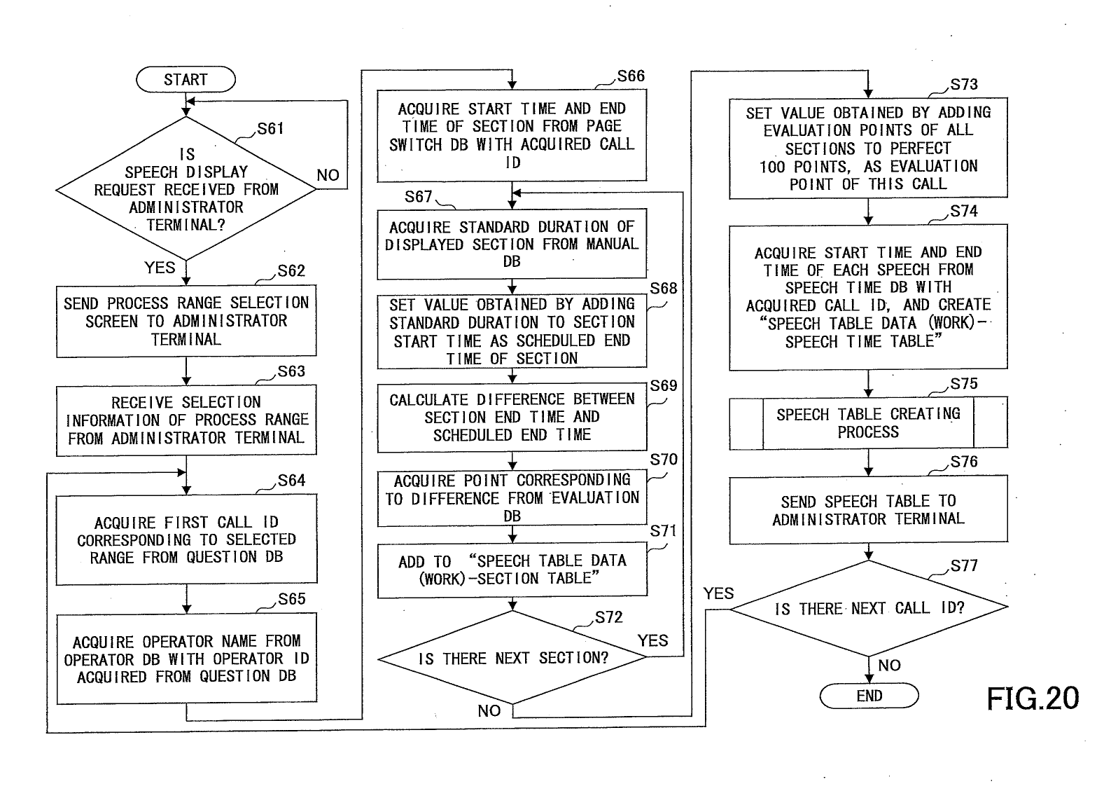

FIG. 20 is a flowchart of a process according to the OP evaluation program 22. In step S61, the speech selecting unit 113 waits until a speech display request is received from the administrator terminal 3. When a speech display request is received from the administrator terminal 3, in step S62, the speech selecting unit 113 sends a process range selection screen described below to the administrator terminal 3.

The administrator terminal 3 that has received the process range selection screen displays the process range selection screen described below and prompts the administrator to input selection information of the process range. The administrator terminal 3 sends the selection information of the process range input by the administrator, to the server 1. In step S63, the speech selecting unit 113 receives the selection information of the process range from the administrator terminal 3.

In step S64, the call status acquiring unit 112 acquires, from the question DB 12, a record of the first call ID corresponding to the selection information of the process range received from the administrator terminal 3.

In step S65, the call status acquiring unit 112 uses the operator ID included in the record acquired from the question DB 12 in step S64 to acquire an operator name from the operator DB 15.

In step S66, the call status acquiring unit 112 uses the first call ID corresponding to the selection information of the process range received from the administrator terminal 3, to acquire a start time and an end time of a section, from the page switch DB 19. The start time of the section is the time associated with the display operation. The end time of the section is the time associated with the hiding operation.

In step S67, the call status acquiring unit 112 acquires the manual ID and the section no. from the page switch DB 19, by using the first call ID corresponding to the selection information of the process range received from the administrator terminal 3. The call status acquiring unit 112 acquires, from the manual DB 18, the standard duration of the section displayed by the operator, by using the acquired manual ID and section no.

In step S68, the call status acquiring unit 112 sets, as the scheduled end time of the section, a value obtained by adding the standard duration to the start time of the section acquired in step S66.

In step S69, the call status acquiring unit 112 calculates the difference between the end time of the section acquired in step S66 and the scheduled end time of the section calculated at step S68.

In step S70, the call evaluating unit 111 acquires, from the evaluation DB 20, an evaluation point corresponding to the difference between the end time of the section calculated at step S69 and the scheduled end time of the section. In step S71, the call evaluating unit 111 adds a record to the speech table data (work)-section table described below.

In step S72, the call status acquiring unit 112 determines whether there is a next section. When there is a next section, the call status acquiring unit 112 performs the process starting from step S67 again.

When there is no next section, in step S73, the call evaluating unit 111 refers to the speech table data (work)-section table, and sets a value obtained by adding the evaluation points of all sections to the perfect 100 points, as the evaluation point of this call. Then, the call evaluating unit 111 creates the speech table data (work)-call summary information described below.

In step S74, the speech table creating unit 110 uses the first call ID corresponding to the selection information of the process range received from the administrator terminal 3, to acquire the start time and the end time of each speech from the speech time DB 17, and creates the speech table data (work)-speech time table described below.

In step S75, the speech table creating unit 110 performs a speech table creating process. In step S76, the speech table sending unit 109 sends the speech table to the administrator terminal 3 that received the speech table display request. In step S77, the call status acquiring unit 112 determines whether there is a record of the next call ID corresponding to the selection information of the process range received from the administrator terminal 3, in the question DB 12.

When there is a record of the next call ID, in step S64, the call status acquiring unit 112 acquires the record of the next call ID from the question DB 12, and performs the process of step S65 and onward. When there is no record of a next call ID, the call status acquiring unit 112 ends the process of the flowchart of FIG. 20.

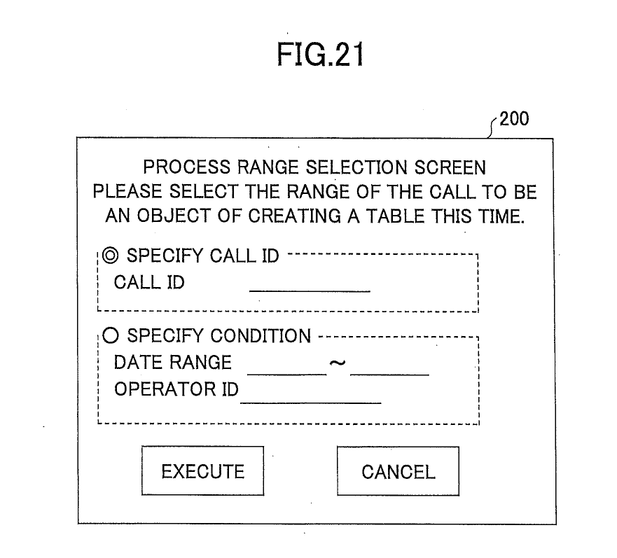

FIG. 21 is an image diagram of a process range selection screen 200. The process range selection screen 200 is used by the administrator for inputting selection information of the process range. The process range selection screen 200 prompts the administrator to specify a call ID or to specify a condition (date range or operator ID), as the selection information of the process range.

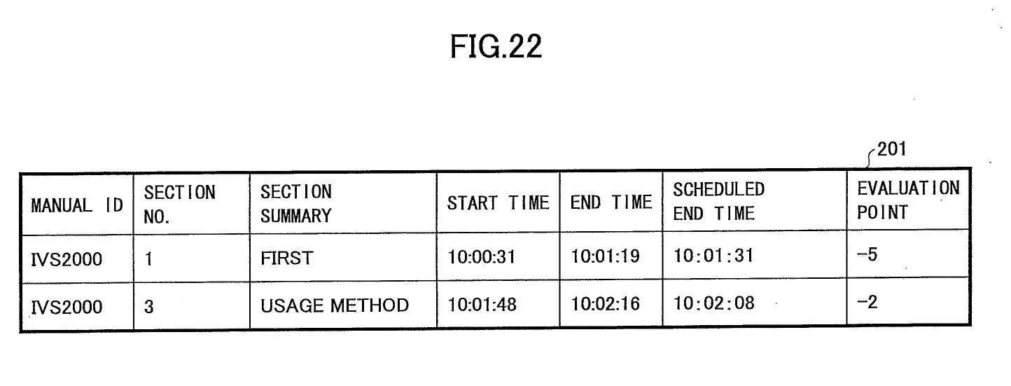

FIG. 22 illustrates a configuration of a speech table data (work)-section table 201. The speech table data (work)-section table 201 includes data items such as a manual ID, a section no., a section summary, a section start time, a section end time, a scheduled section end time, and an evaluation point.

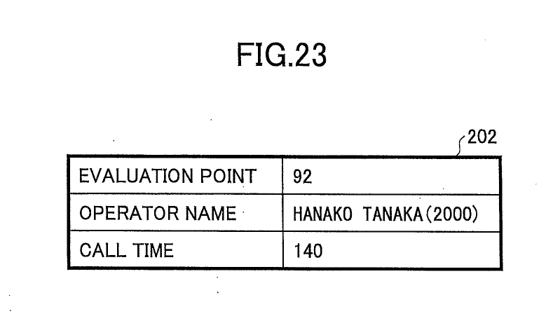

FIG. 23 illustrates a configuration of the speech table data (work)-call summary information 202. The speech table data (work)-call summary information 202 includes data items such as an evaluation point, an operator name, and a call time. The data item “evaluation point” is a value obtained by adding the evaluation points of all section points to the perfect 100 points.

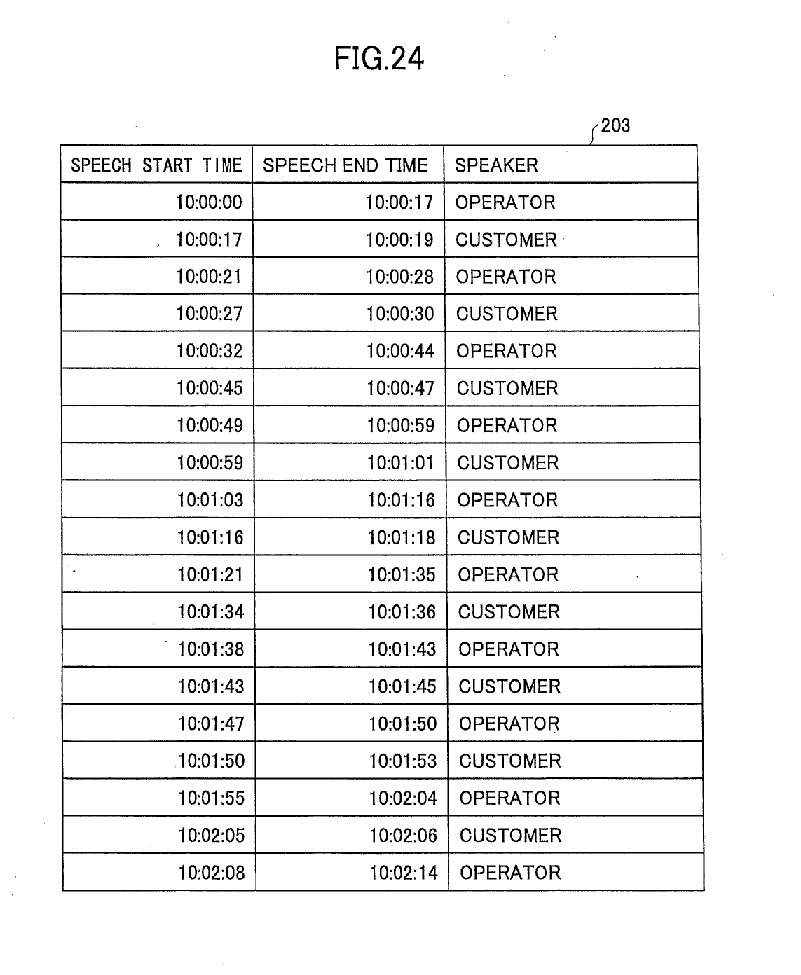

FIG. 24 illustrates a configuration of a speech table data (work)-speech time table 203. The speech table data (work)-speech time table 203 includes data items such as the start time and the end time of each speech, and the speaker. The speech table data (work)-speech time table 203 is for recording the start time and the end time of each speech and the speaker in association with each other.

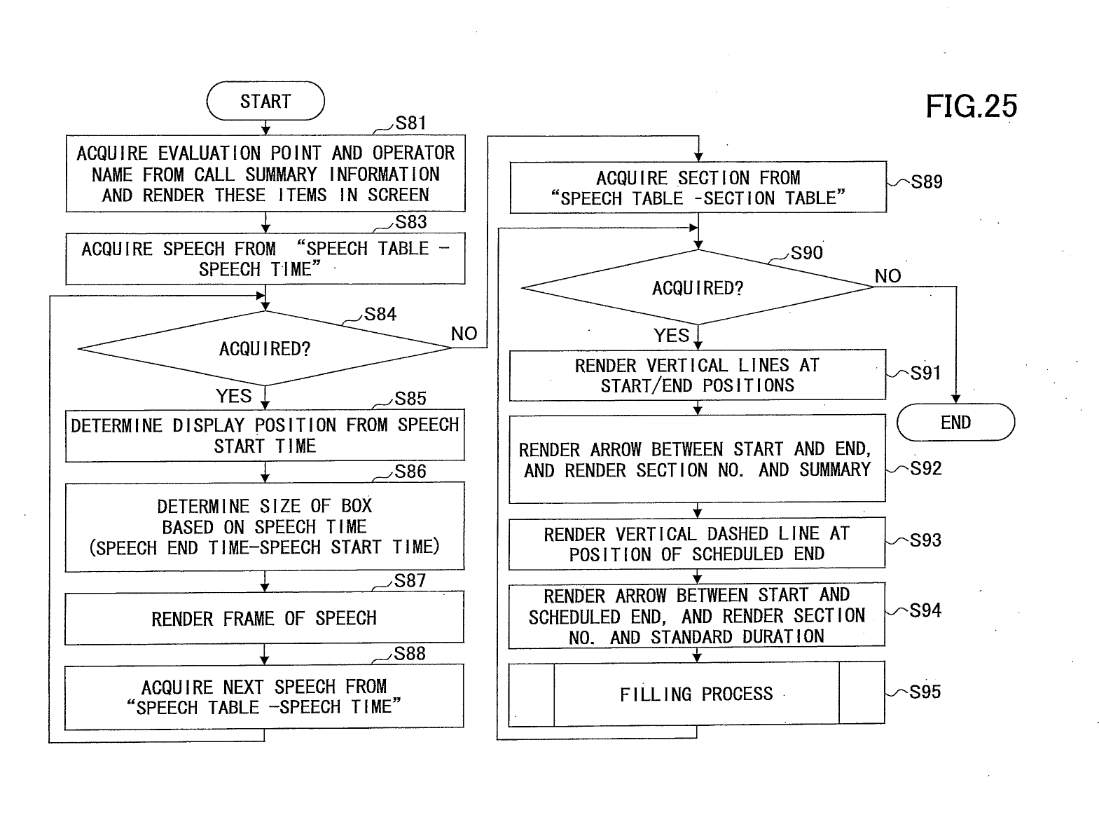

FIG. 25 is a flowchart of a speech table creating process. In step S81, the speech table creating unit 110 acquires an evaluation point and an operator name from the speech table data (work)-call summary information 202, and renders these items in the screen.

In step S83, the speech table creating unit 110 sequentially acquires records from the speech table data (work)-speech time table 203. In step S84, the speech table creating unit 110 determines whether the record has been acquired.

When the record has been acquired, in step S85, the speech table creating unit 110 determines the display position based on the start time of the speech. In step S86, the speech table creating unit 110 determines the size of a box (frame of speech) indicating the speech in the screen, based on the time of the speech (speech end time-speech start time). In step S87, the speech table creating unit 110 renders the frame of the speech in the screen.

In step S88, the speech table creating unit 110 acquires the next record from the speech table data (work)-speech time table 203. The speech table creating unit 110 repeats steps S84 through S88 until it is not possible to acquire the next record.

In step S84, the when the speech table creating unit 110 determines that it is not possible to acquire a record, in step S89, the speech table creating unit 110 sequentially acquires records from the speech table data (work)-section table 201. In step S90, the speech table creating unit 110 determines whether a record is acquired.

When a record is acquired, in step S91, the speech table creating unit 110 renders vertical lines at the positions of the section start time and the section end time. In step S92, the speech table creating unit 110 renders an arrow between the vertical lines rendered at step S91, and renders the section no. and the section summary.

In step S93, the speech table creating unit 110 renders a vertical dashed line at the position of the scheduled section end time. In step S94, the speech table creating unit 110 renders an arrow between the vertical line rendered at the position of the section start time and the dashed vertical line rendered at the position of the scheduled section end time, and renders the section no. and the standard duration.

In step S95, the speech table creating unit 110 performs a filling process. After the filling process, the speech table creating unit 110 performs the process of step S90. The speech table creating unit 110 repeats steps S90 through S95 until it is not possible to acquire a record. In step S90, when the speech table creating unit 110 determines that it is not possible to acquire a record, the process of the flowchart of FIG. 25 ends.

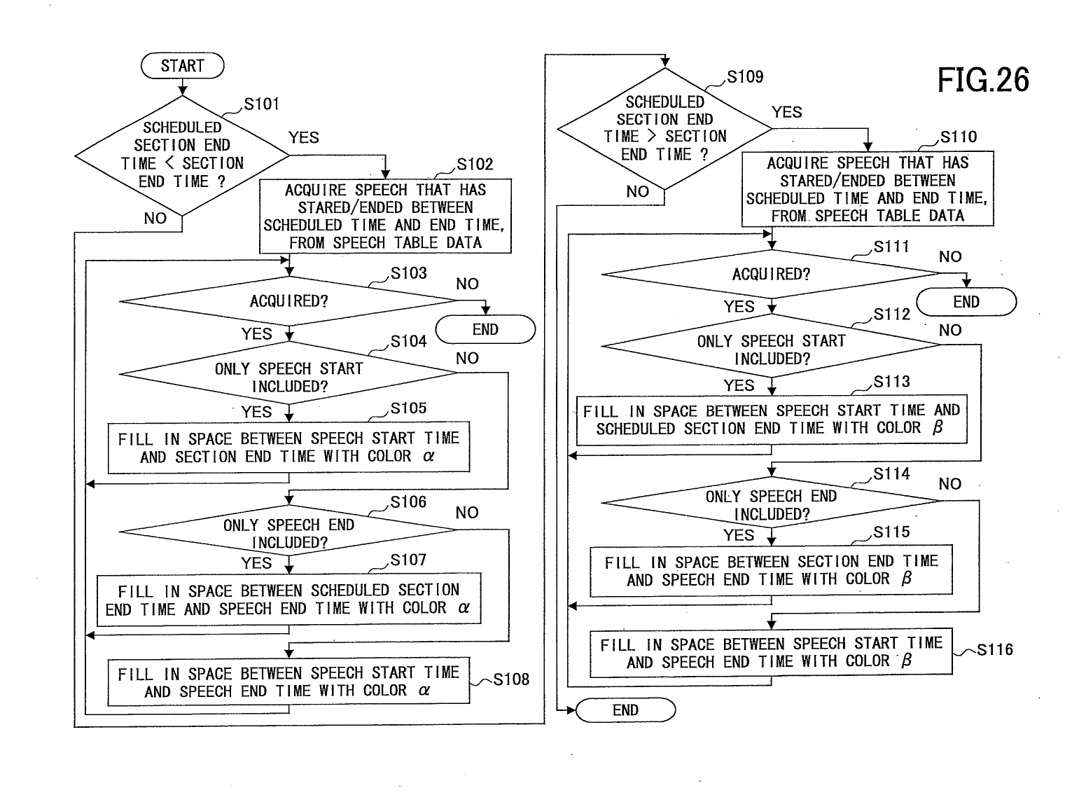

FIG. 26 is a flowchart of a filling process. In step S101, the speech table creating unit 110 determines whether the section end time has passed the scheduled section end time.

When the section end time has passed the scheduled section end time, in step S102, the speech table creating unit 110 acquires, from the speech table data (work)-speech time table 203, a record of a speech that has stared or ended between the scheduled section end time and the section end time.

In step S103, the speech table creating unit 110 determines whether a record has been acquired. When a record has been acquired, in step S104, the speech table creating unit 110 determines whether only the speech start time is included between the scheduled section end time and the section end time.

When only the speech start time is included between the scheduled section end time and the section end time, in step S105, the speech table creating unit 110 fills in the space between the speech start time and the section end time, with a color α.

When only the speech start time is not included between the scheduled section end time and the section end time, in step S106, the speech table creating unit 110 determines whether only the speech end time is included between the scheduled section end time and the section end time.

When only the speech end time is included between the scheduled section end time and the section end time, in step S107, the speech table creating unit 110 fills in the space between the scheduled section end time and the speech end time, with a color a.

When only the speech end time is not included between the scheduled section end time and the section end time, in step S108, the speech table creating unit 110 fills in the space between the speech start time and the speech end time, with a color a.

After the process of steps S105, S107, and S108, the speech table creating unit 110 performs the process of step S103 again. In step S103, when it is not possible to acquire a record, the process of the flowchart of FIG. 26 ends.

In step S101, when the section end time has not passed the scheduled section end time, in step S109, the speech table creating unit 110 determines whether the section end time is before the scheduled section end time.

When the section end time is before the scheduled section end time, in step S110, the speech table creating unit 110 acquires, from the speech table data (work)-speech time table 203, a record of a speech that has started or ended between the scheduled section end time and the section end time.

In step S111, the speech table creating unit 110 determines whether a record has been acquired. When a record has been acquired, in step S112, the speech table creating unit 110 determines whether only the speech start time is included between the scheduled section end time and the section end time.

When only the speech start time is included between the scheduled section end time and the section end time, in step S113, the speech table creating unit 110 fills in the space between the speech start time and the scheduled section end time, with a color β.

When only the speech start time is not included between the scheduled section end time and the section end time, in step S114, the speech table creating unit 110 determines whether only the speech end time is included between the scheduled section end time and the section end time.

When only the speech end time is included between the scheduled section end time and the section end time, in step S115, the speech table creating unit 110 fills in the space between the section end time and the speech end time, with a color β.

When only the speech end time is not included between the scheduled section end time and the section end time, in step S116, the speech table creating unit 110 fills in the space between the speech start time and the speech start time, with a color β.

After the process of steps S113, S115, and S116, the speech table creating unit 110 performs the process of step S111 again. In step S111, when it is not possible to acquire a record, the process of the flowchart of FIG. 26 ends. Furthermore, in step S109, when the section end time is not before the scheduled section end time, the speech table creating unit 110 ends the process of the flowchart of FIG. 26.

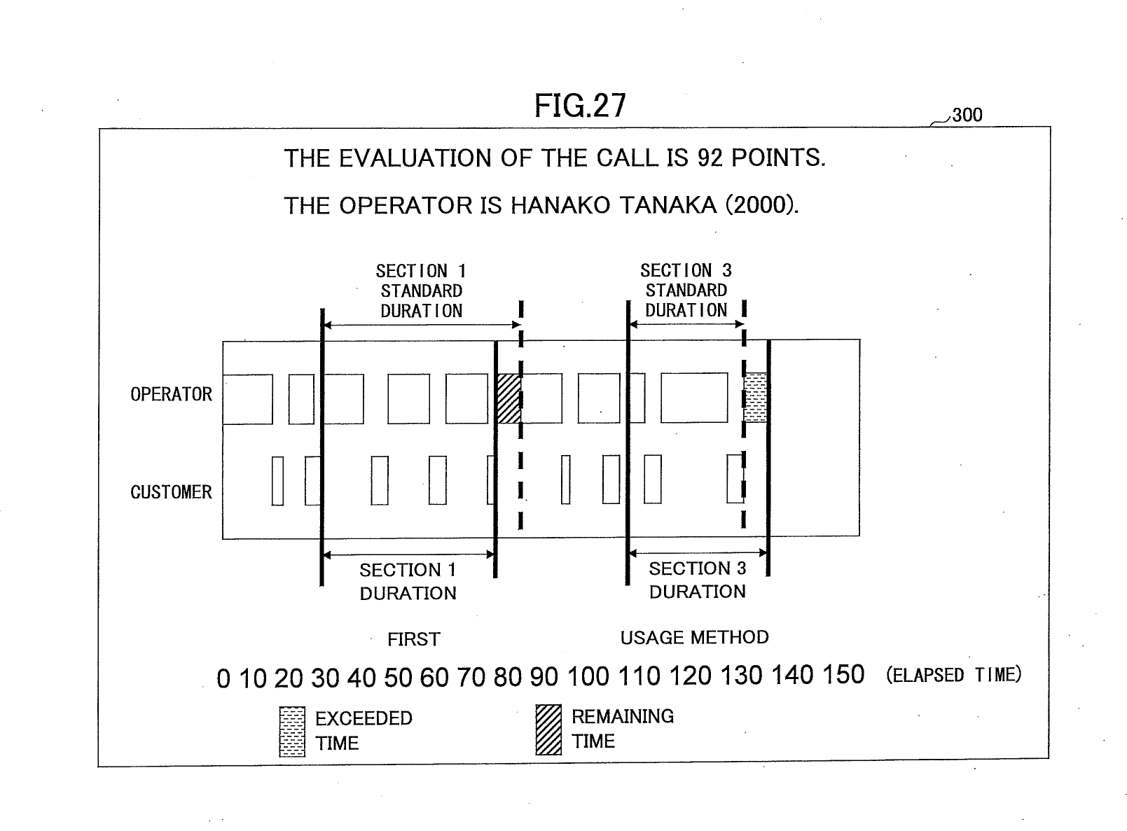

FIG. 27 is screen image diagram of a speech table. In a speech table 300 of FIG. 27, an evaluation point, an operator name, frames of speech of the operator and the customer, vertical lines expressing the positions of the section start time and the section end time, an arrow rendered between the vertical lines, a section no. and a section summary, a dashed vertical line expressing the position of the scheduled section end time, an arrow rendered between the vertical line (section start time) and the vertical dashed line, the section no. and the standard duration are displayed.

For example, by clicking a frame of the speech of the operator and a customer with a mouse, the speech table 300 is able to play recorded speeches of the operator and the customer. In the speech table 300 of FIG. 27, the elapsed time is expressed by a relative time instead of the actual time. The time may be easily switched between the actual time and the relative time.

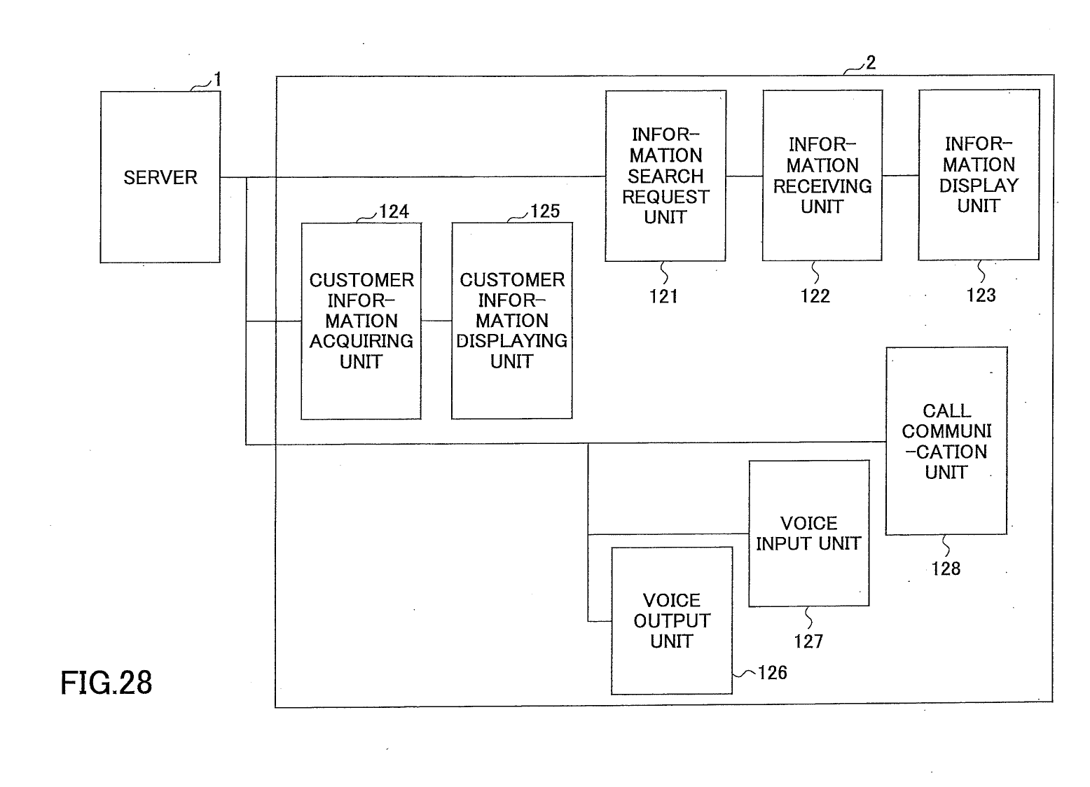

FIG. 28 is a function configuration diagram of the operator terminal 2. The operator terminal 2 includes an information search request unit 121, an information receiving unit 122, an information display unit 123, a customer information acquiring unit 124, a customer information displaying unit 125, a voice output unit 126, a voice input unit 127, and a call communication unit 128.

By executing the operator program 31, the operator terminal 2 realizes the information search request unit 121, the information receiving unit 122, the information display unit 123, the customer information acquiring unit 124, the customer information displaying unit 125, the voice output unit 126, the voice input unit 127, and the call communication unit 128.

The information search request unit 121 makes a search request for information to the server 1. The information receiving unit 122 receives the search result of information from the server 1. The information display unit 123 displays the search result on the display device 71.

The customer information acquiring unit 124 receives information of the customer from the server 1. The customer information displaying unit 125 displays the information of the customer on the display device 71. The voice output unit 126 outputs a voice with the speaker 91. The voice input unit 127 inputs a voice from the microphone 92. The call communication unit 128 communicates with the customer terminal 4.

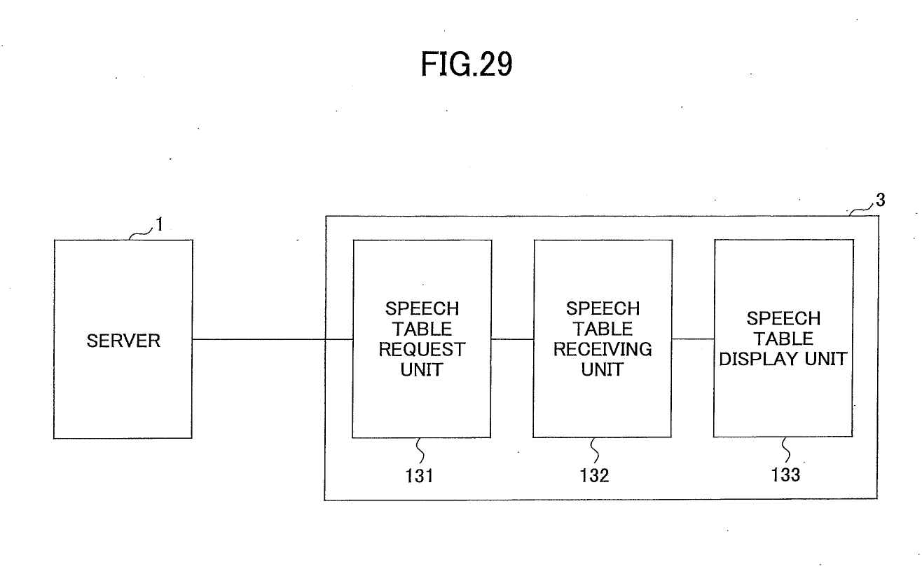

FIG. 29 is a function configuration diagram of the administrator terminal 3. The administrator terminal 3 includes a speech table request unit 131, a speech table receiving unit 132, and a speech table display unit 133. The speech table request unit 131 makes a speech table display request to the server 1. The speech table receiving unit 132 receives the speech table 300 from the server 1. The speech table display unit 133 displays the speech table 300 as illustrated in FIG. 27 on the display device 71.

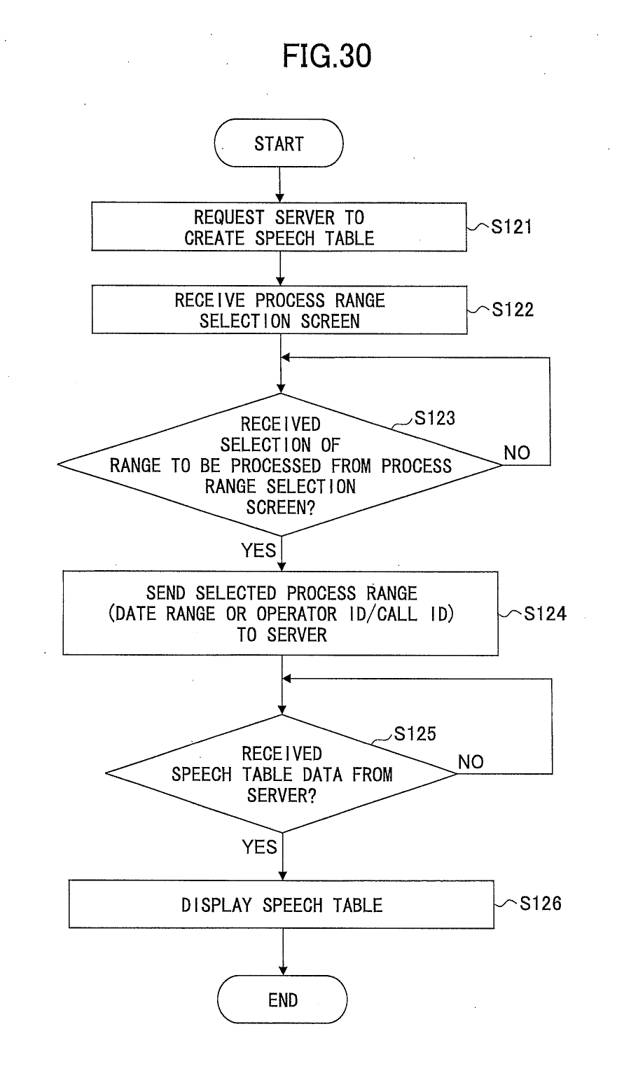

FIG. 30 is a flowchart of a process performed by the administrator terminal 3. In step S121, the speech table request unit 131 of the administrator terminal 3 requests the server 1 to create a speech table. In step S122, the speech table request unit 131 receives the process range selection screen 200 from the administrator terminal 3.

In step S123, the speech table request unit 131 displays the process range selection screen 200 and prompts the administrator to input selection information of the process range. Until the speech table request unit 131 determines that selection information of the process range is input from the administrator, the process of step S123 is repeated.

When selection information of the process range is input from the administrator, in step S124, the speech table request unit 131 sends selection information of the process range (specification of call ID or specification of condition (date range or operator ID)) to the server 1. The speech table receiving unit 132 repeats the process of step S125 until the data of the speech table 300 is received from the server 1. Then, when the data of the speech table 300 is received from the server 1, in step S126, the speech table display unit 133 displays the speech table 300 on the display device 71.

As described above, the server 1 according to the present embodiment may create the speech table 300 as illustrated in FIG. 27 and send the speech table 300 to the administrator terminal 3. In conjunction with a graph indicating the speech time periods of the operator and the customer, the speech table 300 indicates the display time period and the display contents of a manual displayed in the screen of the operator terminal 2 by the operator. Furthermore, the speech table 300 indicates the standard duration for each display content, and indicates the difference between the operator's duration and the standard duration for each display content.

By using the speech table 300, the administrator may easily find the portion of the problem in a call from a customer attended to by an operator, as described below. The administrator may easily predict that the portion, where the difference between the operator's duration and the standard duration is large in the speech table 300, is highly likely to the portion of the problem in a call from a customer attended to by an operator.

Furthermore, the speech table 300 indicates the display time period and the display contents of a displayed manual. Therefore, the administrator may predict, to some extent, the contents of the speech, before playing the recorded speech of the operator and the customer. By performing a statistical process on the frequency that a problem occurs for the respective display contents (pages of manual), the administrator may obtain reference information for improving the display contents.

A speech recording unit corresponds to the speech time DB 17. A display recording unit corresponds to the page switch DB 19. A content recording unit corresponds to the manual DB 18. A providing unit corresponds to the speech table sending unit 109. An evaluation recording unit corresponds to the evaluation DB 20. An evaluation unit corresponds to the call evaluating unit 111. An operator evaluation support program corresponds to the OP evaluation program 22.

The elements, expressions, and arbitrary combinations of elements according to an embodiment of the present invention may be applied to a method, a device, a system, a computer program, a recording medium, and a data structure, which are also valid as an embodiment of the present invention.

According to an aspect of the embodiments, an operator evaluation support device and an operator evaluation support method are provided, by which the portion of a problem in a call from a customer attended to by an operator may be easily found.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An operator evaluation support device comprising:
a speech recording unit configured to record speech times of a customer and an operator during a telephone call from the customer to which the operator attends;
a display recording unit configured to record a display time during which a display screen is displayed during the telephone call on an operator terminal used by the operator, in association with display screen identification information for identifying the display screen;
a content recording unit configured to record screen content information describing a content of the display screen, in association with the display screen identification information of the display screen displayed on the operator terminal; and
a providing unit configured to refer to the speech recording unit,
the display recording unit, and the content recording unit with respect to the telephone call,
create telephone call information indicating the speech times of the customer and the operator, the display time of the display screen displayed on the operator terminal, and the screen content information corresponding to the display screen, and
send the telephone call information to an administrator terminal used by an administrator who is evaluating the operator.

2. The operator evaluation support device according to claim 1, wherein
the content recording unit is configured to further record a standard display time that is a standard, in association with the display screen identification information, and
the providing unit is configured to refer to the content recording unit, identify the standard display time corresponding to the display screen displayed during the telephone call, and create the telephone call information indicating the standard display time.

3. The operator evaluation support device according to claim 2, further comprising:
an evaluation recording unit configured to record evaluation information based on the display time of the display screen displayed on the operator terminal and the standard display time of the display screen; and
an evaluation unit configured to refer to the evaluation recording unit, and acquire the evaluation information based on the display time of the display screen during the telephone call and the standard display time of the display screen, wherein
the providing unit is configured to create the telephone call information including the evaluation information.

4. The operator evaluation support device according to claim 2, wherein
the providing unit is configured to
display the speech times of the customer and the operator and the display time of the display screen during the telephone call based on a time axis,
identify an end time point when the standard display time of the display screen ends by using, as an origin, a display start time point of the display screen, and
display the end time point based on the time axis.

5. The operator evaluation support device according to claim 1, wherein
the display recording unit is configured to record the display time of the display screen displayed on the operator terminal, for the display screen whose standard display time is recorded in the content recording unit among the display screens displayed on the operator terminal.

6. The operator evaluation support device according to claim 1, wherein
the display recording unit is configured to record the display time of each page of a manual used by the operator for giving explanations.

7. An operator evaluation support method executed by a computer, the operator evaluation support method comprising:
referring to a display recording unit that records a display time during which a display screen is displayed on an operator terminal used by an operator during a telephone call from a customer to which the operator attends, the display time being recorded in association with display screen identification information for identifying the display screen, and identifying the display screen identification information and the display time of the display screen displayed on the operator terminal during the telephone call;
referring to a content recording unit that records screen content information describing a content of the display screen, in association with the display screen identification information of the display screen displayed on the operator terminal, and identifying the screen content information corresponding to the display screen identification information that has been identified;
referring to a speech recording unit that records speech times of the customer and the operator during the telephone call, and identifying the speech times of the customer and the operator during the telephone call;
creating telephone call information indicating the identified speech times of the customer and the operator, the identified display time of the display screen displayed on the operator terminal, and the identified screen content information corresponding to the display screen, with respect to the telephone call; and
sending the telephone call information to an administrator terminal used by an administrator who is evaluating the operator.

8. The operator evaluation support method according to claim 7, further comprising:
referring to the content recording unit that further records a standard display time that is a standard, in association with the display screen identification information, identifying the standard display time corresponding to the identified display screen identification information of the telephone call, and creating the telephone call information indicating the standard display time.

9. The operator evaluation support method according to claim 8, further comprising:
referring to an evaluation recording unit that records evaluation information based on the display time of the display screen displayed on the operator terminal and the standard display time of the display screen, and acquiring the evaluation information defined by the display time of the display screen during the telephone call and the standard display time of the display screen; and
creating the telephone call information including the evaluation information.

10. The operator evaluation support method according to claim 8, further comprising:
displaying the speech times of the customer and the operator and the display time of the display screen during the telephone call based on a time axis, identifying an end time point when the standard display time of the display screen ends by using, as an origin, a display start time point of the display screen, and displaying the end time point based on the time axis.

11. The operator evaluation support method according to claim 7, further comprising:
recording, in the display recording unit, the display time of the display screen displayed on the operator terminal, for the display screen whose standard display time is recorded in the content recording unit among the display screens displayed on the operator terminal.

12. The operator evaluation support method according to claim 7, further comprising:
recording, in the display recording unit, a display time of each page of a manual displayed on the operator terminal, the manual being used by the operator for giving explanations.

13. A non-transitory computer-readable recording medium storing an operator evaluation support program that causes a computer to execute a process comprising:
referring to a display recording unit that records a display time during which a display screen is displayed on an operator terminal used by an operator during a telephone call from a customer to which the operator attends, the display time being recorded in association with display screen identification information for identifying the display screen, and identifying the display screen identification information and the display time of the display screen displayed on the operator terminal during the telephone call;
referring to a content recording unit that records screen content information describing a content of the display screen, in association with the display screen identification information of the display screen displayed on the operator terminal, and identifying the screen content information corresponding to the display screen identification information that has been identified;
referring to a speech recording unit that records speech times of the customer and the operator during the telephone call, and identifying the speech times of the customer and the operator during the telephone call;
creating telephone call information indicating the identified speech times of the customer and the operator, the identified display time of the display screen displayed on the operator terminal, and the identified screen content information corresponding to the display screen, with respect to the telephone call; and
sending the telephone call information to an administrator terminal used by an administrator who is evaluating the operator.

14. The non-transitory computer-readable recording medium according to claim 13, the process further comprising:
referring to the content recording unit that further records a standard display time that is a standard, in association with the display screen identification information, identifying the standard display time corresponding to the identified display screen identification information of the telephone call, and creating the telephone call information indicating the standard display time.

15. The non-transitory computer-readable recording medium according to claim 14, the process further comprising:
referring to an evaluation recording unit that records evaluation information based on the display time of the display screen displayed on the operator terminal and the standard display time of the display screen, and acquiring the evaluation information defined by the display time of the display screen during the telephone call and the standard display time of the display screen; and
creating the telephone call information including the evaluation information.

16. The non-transitory computer-readable recording medium according to claim 14, the process further comprising:
displaying the speech times of the customer and the operator and the display time of the display screen during the telephone call based on a time axis, identifying an end time point when the standard display time of the display screen ends by using, as an origin, a display start time point of the display screen, and displaying the end time point based on the time axis.

17. The non-transitory computer-readable recording medium according to claim 13, the process further comprising:
recording, in the display recording unit, the display time of the display screen displayed on the operator terminal, for the display screen whose standard display time is recorded in the content recording unit among the display screens displayed on the operator terminal.

18. The non-transitory computer-readable recording medium according to claim 13, the process further comprising:
recording, in the display recording unit, a display time of each page of a manual displayed on the operator terminal, the manual being used by the operator for giving explanations.
